(19) United States
(12) Patent Application Publication
(10) Pub. No.: US 2025/0159717 A1
(43) Pub. Date: May 15, 2025

(54) SCHEDULING IN A COMMUNICATION NETWORK

(71) Applicant: Telefonaktiebolaget LM Ericsson (publ), Stockholm (SE)

(72) Inventors: Du Ho KANG, Sollentuna (SE); Jose Luis PRADAS, Stockholm (SE); Richard TANO, Stockholm (SE); Jonathan PALM, Luleå (SE)

(21) Appl. No.: 18/729,726

(22) PCT Filed: Jan. 28, 2023
(86) PCT No.: PCT/SE2023/050075

§ 371 Date: Jul. 17, 2024

Related U.S. Application Data
(60) Provisional application No. 63/304,539, filed on Jan. 28, 2022.

(51) Int. Cl. H04W 72/566; H04W 72/1268

(52) U.S. Cl. CPC H04W 72/569; H04W 72/1268

(57) ABSTRACT

A method performed by a communication device is disclosed. The communication device receives data units (D) on logical channels. The communication device receives schedules the received data units (D) for transmission based on a priority order of the logical channels and based on timing information (T) for the data units (D). In some embodiments, the timing information (T) includes, for each data unit (D), a time budget remaining (TBR) for the data unit (D) to meet a timing requirement.

### TECHNICAL FIELD

The present application relates generally to a communication network and relates more particularly to scheduling in such a communication network.

### BACKGROUND

A communication device operating in a 5G network may implement a medium access control (MAC) entity which receives data on one or more logical channels from a higher layer. The MAC entity schedules the received data for transmission, e.g., on one or more transport layers offered by the MAC entity to a lower layer. Such scheduling may for instance involve selecting one or more logical channels to which to allocate resources for a transmission, and then allocating resources to the selected logical channel(s), e.g., according to a prioritization of the logical channel(s).

Logical channel prioritization as implemented heretofore involves selection of the data in the different logical channels based on a pre-set priority and in a pre-set bucket size. This results in a simple and predictable method to select data from the different queues, which may be acceptable when for some types of traffic, such as enhanced Mobile Broadband (eMBB) traffic, e.g., bursty traffic with random arrival times which do not have tight timing requirements. Existing approaches prove problematic, though, for other types of traffic, such as for extended Reality (XR) traffic, which have inherent timing requirements which need to be met to comply with the agreed quality of service (QOS).

### SUMMARY

According to some embodiments herein, a communication device implements delay-aware scheduling. The communication device in this regard may perform scheduling of data units for transmission, with an awareness of how long each data unit has been and/or can be delayed yet still meet a timing requirement, e.g., in compliance with a quality of service specified for that data unit.

Some embodiments for example include a method to select queued data from different logical channel identities (LCIDs). Some embodiments for example select the queued data based on the time a packet has been queued in the buffer and the packet delay budget that is left to meet timing requirements for that packet. Some embodiments in this regard describe mechanisms for a communication device to select LCIDs, if configured, and select a certain amount of data from each of the selected LCIDs/queues applying the selected prioritization mechanism e.g., delay-aware scheduling.

Certain embodiments may provide one or more of the following technical advantage(s). Some embodiments increase the quality of experience and/or assist meeting the quality of service of a given service by selecting the highest priority data first based on packet delay budget for buffered packets.

More broadly, embodiments herein include a method performed by a communication device. The method comprises receiving data units on logical channels. The method also comprises scheduling the received data units for transmission based on a priority order of the logical channels and based on timing information for the data units.

In some embodiments, the timing information includes, for each data unit, a time budget remaining for the data unit to meet a timing requirement.

In some embodiments, the data units are packets, the timing requirement for a packet is a packet delay budget, and the time budget remaining for a packet comprises an amount of time left before the packet must be delivered to a reference point in order to meet the packet delay budget for the packet.

In one or more embodiments, the method further comprises associating each data unit with a priority based on the time budget remaining for the data unit. In some embodiments, a data unit is associated with a higher priority the smaller the time budget remaining for the data unit. In some embodiments, said scheduling comprises scheduling the data units for transmission based on the priority order of the logical channels and based on the priorities associated with the data units. In one or more of these embodiments, said associating comprises associating each data unit with one of multiple possible priorities based on within which one of multiple time budget ranges the time budget remaining for the data unit belongs.

In one or more embodiments, said associating comprises storing each data unit in a virtual queue based on the time budget remaining for the data unit. In some embodiments, each virtual queue has a priority, and each data unit is associated with the priority of the virtual queue within which the data unit is stored.

In one or more embodiments, said scheduling comprises allocating transmission resources to the logical channels in a decreasing priority order, with transmission resources being allocated for a highest priority virtual queue first for all logical channels.

In one or more embodiments, said scheduling comprises allocating transmission resources to the logical channels in a decreasing priority order, with transmission resources being allocated for transmission of all data units stored in a higher priority virtual queue before transmission resources are allocated for transmission of any data units stored in a lower priority virtual queue.

In one or more embodiments, said scheduling comprises selecting logical channels to which to allocate transmission resources based on a variable computed per logical channel and per virtual queue. In some embodiments, the variable is computed as a function of a prioritized bit rate per logical channel and per virtual queue. In some embodiments, the variable is computed as a function of a bucket size duration per logical channel and per virtual queue.

In one or more embodiments, said scheduling comprises allocating transmission resources to the logical channels in a decreasing priority order, with transmission resources being allocated for transmission of all data units associated with a higher priority before transmission resources are allocated for transmission of any data units associated with a lower priority.

In some embodiments, the method further comprises storing the received data units in buffers at the wireless communication device respectively associated with the logical channels on which the data units are received. In some embodiments, the timing information for the data units includes, for each data unit, an amount of time that the data unit has been stored in one of the buffers.

In some embodiments, receiving the data units comprises receiving the data units on logical channels at a medium access control (MAC) layer of the communication device or at a MAC entity of the communication device.

In some embodiments, the data units are medium access control (MAC) service data units (SDUs).

In some embodiments, said scheduling comprises allocating transmission resources for transmission of the data units. In this case, the transmission resources correspond to available spaces in a data block to be transmitted during a transmission time interval at the communication device.

In some embodiments, the method further comprises receiving, from a network node, signaling indicating one or more of: one or more thresholds governing prioritization for scheduling data units for transmission based on timing information for data units, how many virtual queues data units are to be stored across according to timing information for the data units, a prioritized bit rate per logical channel and per virtual queue buffer, or a bucket size duration per logical channel and per virtual queue

In some embodiments, said scheduling comprises allocating transmission resources to the logical channels based on the priority order of the logical channels and based on the timing information for the data units.

Other embodiments herein include a method performed by a communication device, The method comprises storing data units in buffers based on timing information for the data units. The method also comprises scheduling the data units in the buffers for transmission based on a priority order of the buffers.

In some embodiments, the timing information includes, for each data unit, a time budget remaining for the data unit to meet a timing requirement. In one or more of these embodiments, the data units are packets, the timing requirement for a packet is a packet delay budget, and the time budget remaining for a packet comprises an amount of time left before the packet must be delivered to a reference point in order to meet the packet delay budget for the packet. In one or more of these embodiments, different buffers are for different respective ranges of time budgets remaining. In some embodiments, a buffer for a range of smaller time budgets remaining is prioritized in the priority order higher than a buffer for a range of larger time budgets remaining. In one or more of these embodiments, said storing comprises, for each data unit, determining which one of the ranges a time budget remaining for the data unit is included and storing the data unit in the buffer that is for the determined range.

In some embodiments, said scheduling comprises allocating transmission resources for transmission of data units in the buffers in a decreasing priority order of the buffers.

In some embodiments, said scheduling comprises allocating transmission resources for transmission of data units in the buffers in a decreasing priority order of the buffers, with transmission resources being allocated for transmission of all data units stored in a higher priority buffer before transmission resources are allocated for transmission of any data units stored in a lower priority buffer. In one or more of these embodiments, said scheduling comprises selecting buffers to which to allocate transmission resources based on a variable computed per buffer. In some embodiments, the variable is computed as a function of a prioritized bit rate per buffer. In some embodiments, the variable is computed as a bucket size duration per buffer.

In some embodiments, the timing information for the data units includes, for each data unit, an amount of time that the data unit has been stored in one of the buffers.

In some embodiments, the data units are received at a medium access control (MAC) layer of the communication device or at a MAC entity of the communication device.

In some embodiments, the data units are medium access control (MAC) service data units (SDUs).

In some embodiments, said scheduling comprises allocating transmission resources for transmission of the data units. In this case, the transmission resources correspond to available spaces in a data block to be transmitted during a transmission time interval at the communication device.

In some embodiments, the method further comprises receiving, from a network node, signaling indicating one or more of one or more thresholds governing prioritization for scheduling the data units for transmission based on timing information for data units, a prioritized bit rate per buffer, or a bucket size duration per buffer

In some embodiments, said scheduling comprises allocating transmission resources for transmission of the data units in the buffers based on a priority order of the buffers.

Other embodiments herein include a method performed by a communication device. The method comprises receiving data units on logical channels that are associated with timing information for the data units. The method also comprises scheduling the data units for transmission based on a priority order of the logical channels.

In some embodiments, the timing information includes, for each data unit, a time budget remaining for the data unit to meet a timing requirement. In one or more of these embodiments, the data units are packets, the timing requirement for a packet is a packet delay budget, and the time budget remaining for a packet comprises an amount of time left before the packet must be delivered to a reference point in order to meet the packet delay budget for the packet. In one or more of these embodiments, each data unit is received on a logical channel that is associated with the time budget remaining for the data unit. In one or more of these embodiments, different ones of the logical channels are associated with different respective time budget ranges remaining for the data units.

In some embodiments, receiving the data units comprises receiving the data units on logical channels at a medium access control (MAC) layer of the communication device or at a MAC entity of the communication device.

In some embodiments, the data units are medium access control (MAC) service data units (SDUs).

In some embodiments, said scheduling comprises allocating transmission resources for transmission of the data units. In this case, the transmission resources correspond to available spaces in a data block to be transmitted during a transmission time interval at the communication device.

In some embodiments, said scheduling comprises selecting which logical channels to allocate transmission resources and allocating transmission resources to the selected logical channels in a decreasing priority order.

Other embodiments herein include a method performed by a communication device. The method comprises receiving, from a network node, signaling indicating one or more of: one or more thresholds governing prioritization for performing transmission scheduling based on timing information for data units, how many virtual queues data units are to be stored across according to timing information for the data units, a prioritized bit rate per logical channel and per virtual queue or a prioritized bit rate per buffer, or a bucket size duration per logical channel and per virtual queue or a bucket size duration per buffer.

In some embodiments, the method further comprises performing transmission scheduling based on the signaling.

In some embodiments, the one or more thresholds comprise one or more time budget remaining thresholds governing definition of time budget ranges at the communication device. In this case, the time budget ranges are associated with respective priorities at the communication device.

In some embodiments, the method further comprises providing user data and forwarding the user data to a host computer via the transmission to a base station.

Other embodiments herein include a method performed by a network node configured for use in a communication network. The method comprises transmitting, to a communication device, signaling indicating one or more of: one or more thresholds governing prioritization according to which the communication device is to perform transmission scheduling based on timing information for data units, how many virtual queues data units are to be stored across by the communication device according to timing information for the data units, a prioritized bit rate per logical channel and per virtual queue or a prioritized bit rate per buffer, or a bucket size duration per logical channel and per virtual queue or a bucket size duration per buffer.

In some embodiments, the method further comprises receiving data units from the communication device scheduled based on the signaling.

In some embodiments, the one or more thresholds comprise one or more time budget remaining thresholds governing definition of time budget ranges at the communication device. In some embodiments, the time budget ranges are associated with respective priorities at the communication device.

Embodiments herein further include corresponding apparatus, computer programs, and carriers of those computer programs.

For example, embodiments herein include a communication device, e.g., comprising communication circuitry and processing circuitry. The communication device is configured to receive data units on logical channels. The communication device is further configured to schedule the received data units for transmission based on a priority order of the logical channels and based on timing information for the data units. In one such embodiment, the timing information includes, for each data unit, a time budget remaining for the data unit to meet a timing requirement.

### BRIEF DESCRIPTION OF THE DRAWINGS

FIG. 1 is a block diagram of a communication device and a communication network according to some embodiments.

FIG. 2 is a block diagram of a scheduler according to some embodiments.

FIG. 3A is a block diagram of an example of buffers for logical channels according to some embodiments.

FIG. 3B is a block diagram of an example legacy grant based on logical channel prioritization.

FIG. 3C is a block diagram of an example grant based on logical channel prioritization and timing information according to some embodiments.

FIG. 4 is a line chart of an example of frame latency measured over the radio access network (RAN) according to some embodiments.

FIG. 5 is a line chart of an example of the cumulative distribution functions of the number of transport blocks required to deliver a video frame according to some embodiments.

FIG. 6 is a block chart of an example of the traffic arrival times of different services according to some embodiments.

FIG. 7A is a block diagram of buffers of two logical channels with virtual buffers for packets with different packet delay budgets remaining according to some embodiments.

FIG. 7B is a logic flow diagram of delay-aware scheduling according to some embodiments with LCIDs configured.

FIG. 8A is a block diagram of three buffers for packets with different packet delay budgets remaining according to other embodiments.

FIG. 8B is a logic flow diagram of delay-aware scheduling according to some embodiments without LCIDs configured.

FIG. 9 is a block diagram of three buffers for logical channels defined for different ranges of packet delay budgets remaining according to still other embodiments.

FIG. 10 is a logic flow diagram of a method performed by a communication device according to some embodiments.

FIG. 11 is a logic flow diagram of a method performed by a communication device according to other embodiments.

FIG. 12 is a logic flow diagram of a method performed by a communication device according to still other embodiments.

FIG. 13 is a logic flow diagram of a method performed by a communication device according to yet other embodiments.

FIG. 14 is a logic flow diagram of a method performed by a network node according to some embodiments.

FIG. 15 is a block diagram of a communication device according to some embodiments.

FIG. 16 is a block diagram of a network node according to some embodiments.

FIG. 17 is a block diagram of a communication system in accordance with some embodiments.

FIG. 18 is a block diagram of a user equipment according to some embodiments.

FIG. 19 is a block diagram of a network node according to some embodiments.

FIG. 20 is a block diagram of a host according to some embodiments.

FIG. 21 is a block diagram of a virtualization environment according to some embodiments.

FIG. 22 is a block diagram of a host communicating via a network node with a UE over a partially wireless connection in accordance with some embodiments.

### DETAILED DESCRIPTION

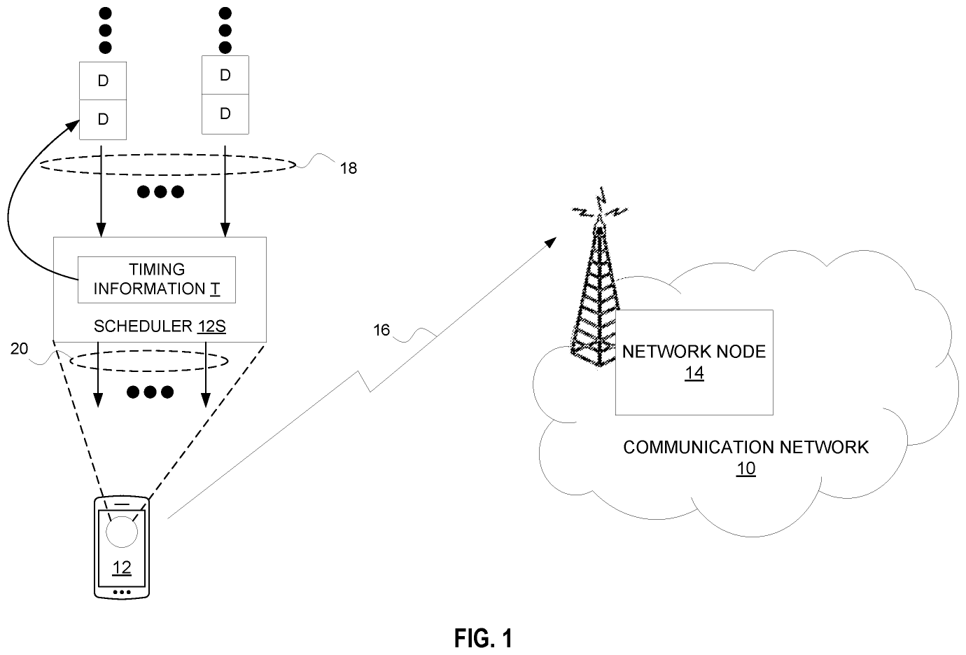

FIG. 1 shows a communication network 10 according to some embodiments. The communication network 10 provides communication service to a communication device 12. In some embodiments, the communication network 10 is a wireless communication network, in which case the communication device 12 communicates with the communication network 10 over a wireless interface 16.

As shown, the communication device 12 receives data units D on logical channels 18. These data units D may for instance be received by a scheduler 12S as shown. In these and other embodiments, the communication device 12 receives data units D on logical channels 18 at a medium access control (MAC) layer of the communication device 12 or at a MAC entity of the communication device 12. In this case, the data units D may be MAC service data units (SDUs).

The communication device 12 schedules the data units D for transmission, e.g., to the communication network 10. Such may involve for instance scheduling the data units D for transmission on one or more transport channels 20 to a lower layer, e.g., which may control transmission on the wireless interface 16 to the communication network. The data units D in these and other embodiments may be segmented and/or aggregated for transmission in data blocks, e.g., on the one or more transport channels 20. Regardless, in some embodiments, scheduling the data units D for transmission involves selecting which logical channels 18 to allocate transmission resources and allocating transmission resources to the selected logical channels 18. Here, transmission resources may for instance correspond to available spaces in a data block to be transmitted during a transmission time interval (TTI) at the communication device 12.

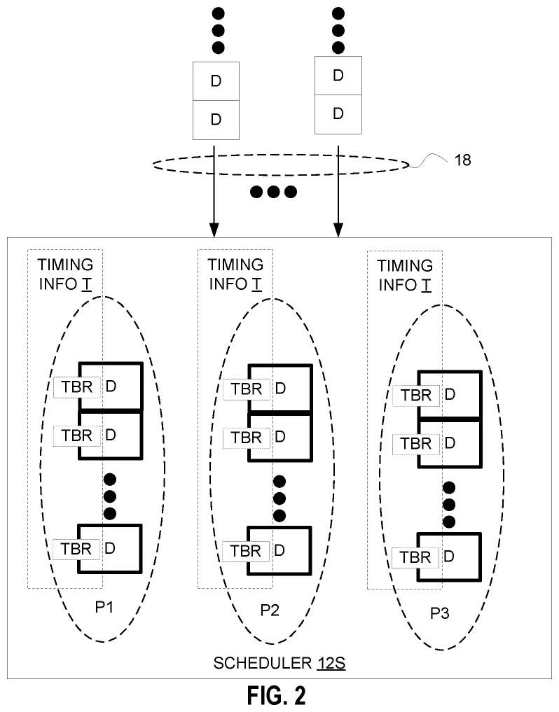

In this context, according to some embodiments herein, the communication device 12 schedules the data units D for transmission based on a priority order of the logical channels 18 and based on timing information T for the data units D. In some embodiments, the timing information T includes, for each data unit D, a time budget remaining (TBR) for the data unit D to meet a timing requirement. For example, where the data units D are packets, the timing requirement for a packet may be a packet delay budget. In this case, the time budget remaining for a packet may comprise an amount of time left before the packet must be delivered to a reference point in order to meet the packet delay budget for the packet. FIG. 2 shows one example.

As shown in FIG. 2, the communication device 12 associates each data unit D with a priority P1, P2, P3, . . . . The communication device 12 may do so based on the time budget remaining (TBR) for the data unit D. Here, then, the TBR for each data unit D constitutes the timing information T. In some embodiments, a data unit D is associated with a higher priority the smaller the time budget remaining for the data unit D. In one embodiment, for example, the communication device 12 associates each data unit D with one of multiple possible priorities P1, P2, P3 based on within which one of multiple time budget remaining ranges the time budget remaining for the data unit D belongs, e.g., with data units D associated with priority P1 having relatively small time budgets remaining, data units associated with priority P2 having moderate time budgets remaining, and data units D associated with priority P3 having relatively larger time budgets remaining.

No matter the particular criteria for prioritizing the data units D, the communication device 12 schedules the data units D for transmission based on the priority order of the logical channels and based on the priorities P1, P2, P3 . . . associated with the data units D. For example, in some embodiments, the communication device 12 allocates transmission resources to the logical channels 18 in a decreasing priority order, with transmission resources being allocated for transmission of all data units D associated with a higher priority before transmission resources are allocated for transmission of any data units D associated with a lower priority.

For example, where P1 is higher in priority than P2 and P2 is higher in priority than P3, the communication device 12 allocates transmission resources for all of the data units D associated with priority P1 before transmission resources are allocated for transmission of any data units D associated with priority P2 or P3. Similarly, the communication device 12 allocates transmission resources for all of the data units D associated with priority P2 before transmission resources are allocated for transmission of any data units D associated with priority P3.

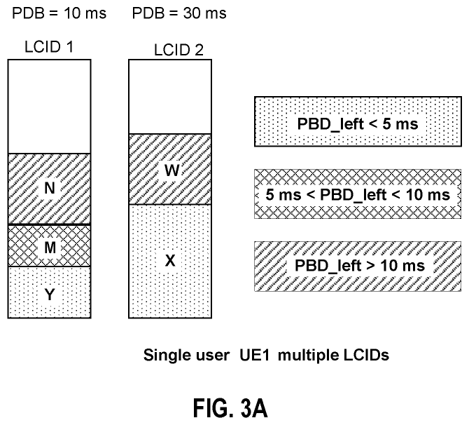

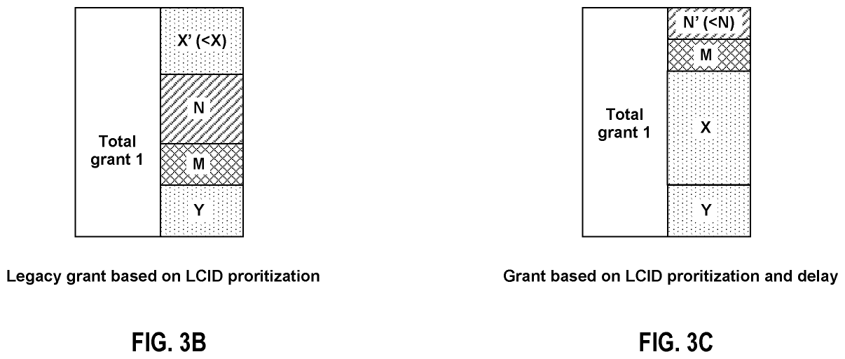

Consider an example shown in FIGS. 3A-3C where the communication device 12 is exemplified as a user equipment (UE) in a 5G network, a data unit D is exemplified as a packet, a logical channel 18 is exemplified as being identified by a logical channel ID (LCID), and timing information T is exemplified as packet delay budget left (PDB_left). FIG. 3A shows buffers of a UE with 2 logical channel identities (LCIDs). Assume LCID 1 and LCID 2 have received application-layer data units (ADUs) from an extended Reality (XR) application, e.g., video and pose with different packet delay budgets (PDBs). Due to the different traffic characteristics of each flow, and the different arrival and/or grant times, there is a different amount of remaining bits (X, Y, M,N,W) in each of the buffers. In addition, at a given LCID, each of the remaining bits also has a different amount of remaining PDB, noted as PDB_left. Each shading corresponds to a different PDB_left (in general, it could be any timing information about the packet and its relation towards the timing requirements).

FIG. 3B shows scheduling according to a legacy approach that is based on LCID prioritization. This legacy approach to logical channel prioritization does not take into account the time packets have been queued and/or whether certain packets have timing requirements to meet. Indeed, in this legacy approach, the UE process to select the LCIDs from which data will be taken from their buffer does not consider delay. As applied to this example, LCID1 is the highest priority LCID and, thus, bits of Y, M, and N will be taken before data from LCID2. As shown in FIG. 3B, then, this leads to only part of X bits (X′<X) being taken from the buffer of LCID2 for the grant. However, X bits should have been prioritized over M and N if PDB_left had been considered.

Accordingly, this legacy scheduling method is sub-optimal if the traffic has inherent timing requirements which need to be met to comply with the agreed quality of service (QOS). Some types of traffic also have the characteristic to be compounded by multiple flows with distinct timing requirements and each flow may have a different average packet size. These additional factors complicate a configuration based only on the priority of the logical channel, the prioritized bit rate (PRB), and the bucket-side duration (BSD).

The network heretofore does not know the PDB_left for the data in each of the LCIDs or logical channel group (LCG) since a user equipment (UE) heretofore provides a buffer status report (BSR) based on buffered data in each LCG. In some embodiments herein, then, the UE provides a delay-aware BSR so as to provide the network with timing information of the queued packets. This allows the network to provide a grant size which may take into account the timing information indicated by the UE. Yet, even if the network provides the correct grant, some embodiments herein enable the UE to apply a logical channel prioritization procedure to make use of the grant adequately.

FIG. 3C shows approaches according to embodiments herein that employ delay-aware scheduling to address the problem illustrated in FIG. 3B. As shown in FIG. 3C, the UE first allocates resources for transmission of Y, and then allocate resources for transmission of X, before allocating any resources for transmission of M or N. After allocating resources for transmission of X, the UE allocates resources for transmission of M. After allocating resources for transmission of M, the UE allocates resources for transmission of N. In this way, the UE allocates resources for only part of N, rather than only part of X as in FIG. 3B.

Although not shown in FIG. 2, in some embodiments, the communication device 12 stores each data unit D in a virtual queue based on the time budget remaining for the data unit D. In some embodiments, it is each virtual queue that has a priority P1, P2, P3. And each data unit D is associated with the priority of the virtual queue within which the data unit D is stored. In one or more of these embodiments, the communication device 12 allocates transmission resources to the logical channels 18 in a decreasing priority order, with transmission resources being allocated for a highest priority virtual queue first for all logical channels 18. In other embodiments, the communication device 12 allocates transmission resources to the logical channels 18 in a decreasing priority order, with transmission resources being allocated for transmission of all data units D stored in a higher priority virtual queue (e.g., P1) before transmission resources are allocated for transmission of any data units D stored in a lower priority virtual queue (e.g., P2 or P3).

Consider an example in a context for a 5G communication network.

5G is the fifth generation of mobile communications, addressing a wide range of use cases from enhanced mobile broadband (eMBB) to ultra-reliable low-latency communications (URLLC) to massive machine type communications (mMTC). 5G includes the New Radio (NR) access stratum interface and the 5G Core Network (5GC). The NR physical and higher layers are reusing parts of the Long Term Evolution (LTE) specification, and to that adds needed components when motivated by new use cases.

Low-latency high-rate applications such as extended Reality (XR) and cloud gaming are important in the 5G era. XR may refer to all real-and-virtual combined environments and human-machine interactions generated by computer technology and wearables. It is an umbrella term for different types of realities including Virtual reality (VR), Augmented reality (AR), Mixed reality (MR), and the areas interpolated among them. The levels of virtuality range from partially sensory inputs to fully immersive VR.

5G NR is designed to support applications demanding high rate and low latency in line with the requirements posed by the support of XR and cloud gaming applications in NR networks.

### Low-Latency High-Rate XR Applications

The low-latency applications like XR and cloud gaming require bounded latency, not necessarily ultra-low latency. The end-to-end latency budget may be in the range of 20-80 ms, which needs to be distributed over several components including application processing latency, transport latency, radio link latency, etc. For these applications, short transmission time intervals (TTIs) or mini-slots targeting ultra-low latency may not be effective.

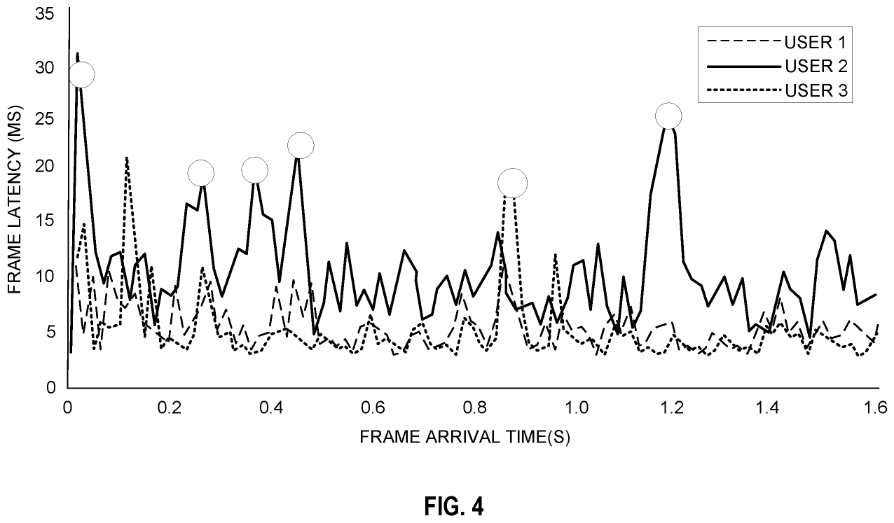

FIG. 4 shows an example of frame latency measured over the radio access network (RAN), excluding application and core network latencies. It can be seen that there exists frame latency spikes in the RAN. The sources for the latency spikes may include queuing delay, time-varying radio environments, and time-varying frame sizes, among others. Tools that can help to remove latency spikes are beneficial to enable better 5G support for this type of traffic.

In addition to bounded latency requirements, the applications like XR and cloud gaming also require high rate transmission. This can be seen from the large frame sizes originated from this type of traffic. The typical frame sizes may range from tens of kilobytes to hundreds of kilobytes. The frame arrival rates may be 60 or 120 frames per second (fps). As a concrete example, a frame size of 100 kilobytes and a frame arrival rate of 120 fps can lead to a rate requirement of 95.8 Mbps.

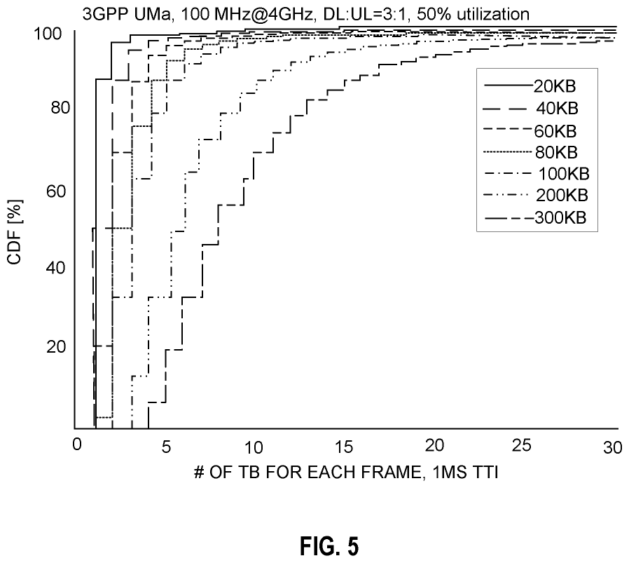

A large video frame Is usually fr″gmen′ed into smaller Internet Protocol (IP) packets and transmitted as several transport blocks (TBs) over several TTIs in the RAN. FIG. 5 shows an example of the cumulative distribution functions of the number of transport blocks required to deliver a video frame with size ranging from 20 KB to 300 KB. For example, FIG. 5 shows that for delivering the frames with a size of 200 KB each, the median number of needed TBs is 5.

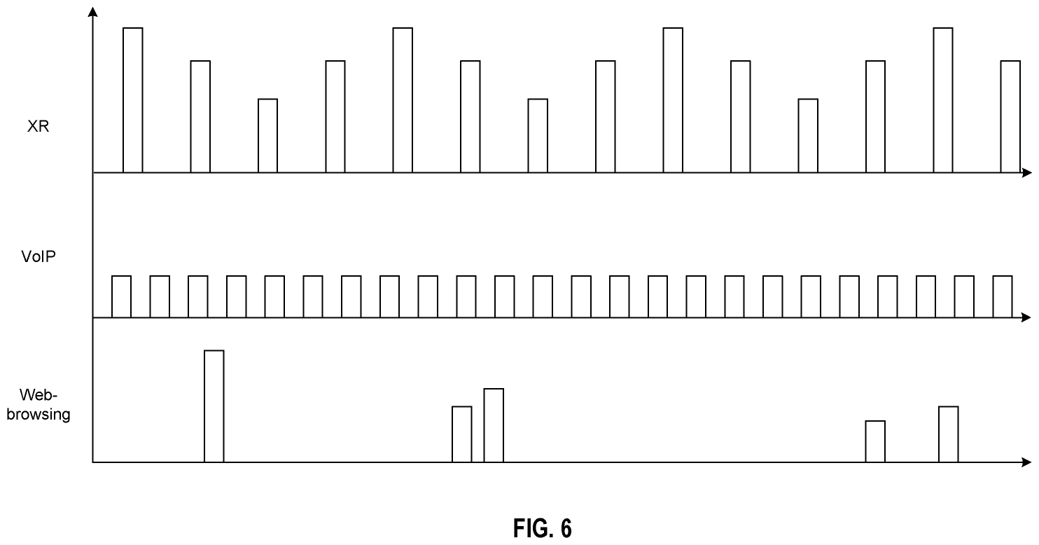

The characteristics of XR traffic″arri′al are quite distinct from typical web-browsing and Voice over IP (VOIP) traffic as shown in FIG. 6. It is well expected that the arrival time is quasi-periodic and largely predictable as VoIP. However, its data size is orders of magnitude larger than VoIP, as discussed above. In addition, similar to web-browsing, the data size is different at every application Protocol Data Unit (PDU) arrival instance due to dynamics of content and human motion.

### Scheduling and Logical Channel Prioritization

When the network provides an uplink (UL) grant to the UE, the UE performs what is called “logical channel prioritization” (LCP) to decide which Logical Channel IDs (LCID) qualify to transmit data given the current grant, and the amount of data to transmit from each of the selected LCIDs. This process as implemented heretofore is explained in 3GPP TS 38.321 v16.7.0 section 5.4.3 and this section provides a simplified version of the full procedure. The procedure is divided into 2 parts: the selection of the logical channels, and the allocation of resources.

The selection of a logical channel is heretofore based on the fulfillment of all the following conditions: (i) the subcarrier spacing associated to the UL grant is listed in the Information Element (IE) ‘allowedSCS-List’ if this IE was configured; (ii) the Physical Uplink Shared Channel (PUSCH) transmission duration associated to the UL grant is shorter than or equal to the value indicated in ‘maxPUSCH-Duration’, if this IE was configured; (iii) configuredGrantType1Allowed, if configured, is set to true in case the UL grant is a Configured Grant Type 1; (iv) the cell information associated to the UL grant is listed in the IE ‘allowedServingCells’, if configured; (v) allowedCG-List, if configured, includes the configured grant index associated to the UL grant; and (vi) allowedPHY-PriorityIndex, if configured, includes the priority index (as specified in clause 9 of TS 38.213 v16.8.0) associated to the dynamic UL grant.

The allocation of the resources i″ heretofore performed as follows. For the selected logical channels for the UL grant with Bj>0 are allocated resources in a decreasing priority order. If the PBR of a logical channel is set to infinity, the MAC entity shall allocate resources for all the data that is available for transmission on the logical channel before meeting the PBR of the lower priority logical channel(s). Bj is decremented by the total size of MAC SDUs served to logical channel j above. if any resources remain, all the selected logical channels are served in a strict decreasing priority order (regardless of the value of Bj) until either the data for that logical channel or the UL grant is exhausted, whichever comes first. Logical channels configured with equal priority should be served equally.

Bj is a variable used and maintained for each logical channel. ‘j’ is an index associated to one Logical Channel Identity. Bj is initialized to zero when the logical channel is established. For each logical channel, Bj is incremented by the product (PBR×T) before every instance of the LCP procedure, where T is the time elapsed since Bj was last incremented. If the value of Bj is greater than the bucket size (i.e. PBR x BSD), Bj is set to the bucket size.

The priority of each of the configured logical channels is provided by Radio Resource Control (RRC). Among others, the iEs ‘priority’, Prioritized Bit Rate (PBR), and Bucket Size Duration (BSD) are indicated. The IE ‘priority’ provides the priority of a logical channel so that a larger value results a lower priority. This results in that value 1 indicates the highest priority.

Some embodiments herein are applicable for making the scheduling described above delay-aware.

In one embodiment in this regard, for each packet the UE buffers, the UE associates a time flag which will be checked later against the latency requirements of the given packet. If LCIDs are configured, then a packet is queued in the buffer associated to a given LCID. Within the given LCID, the UE may have a number of ‘virtual buffers’ each of them defined by a minimum and maximum time thresholds.

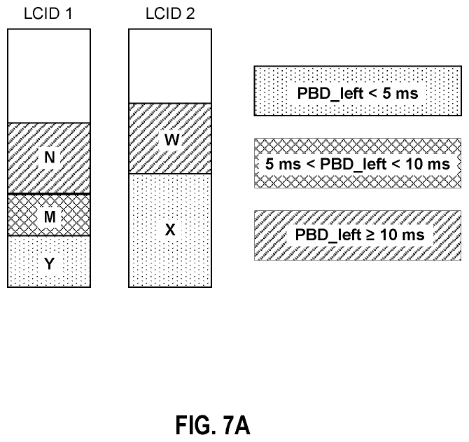

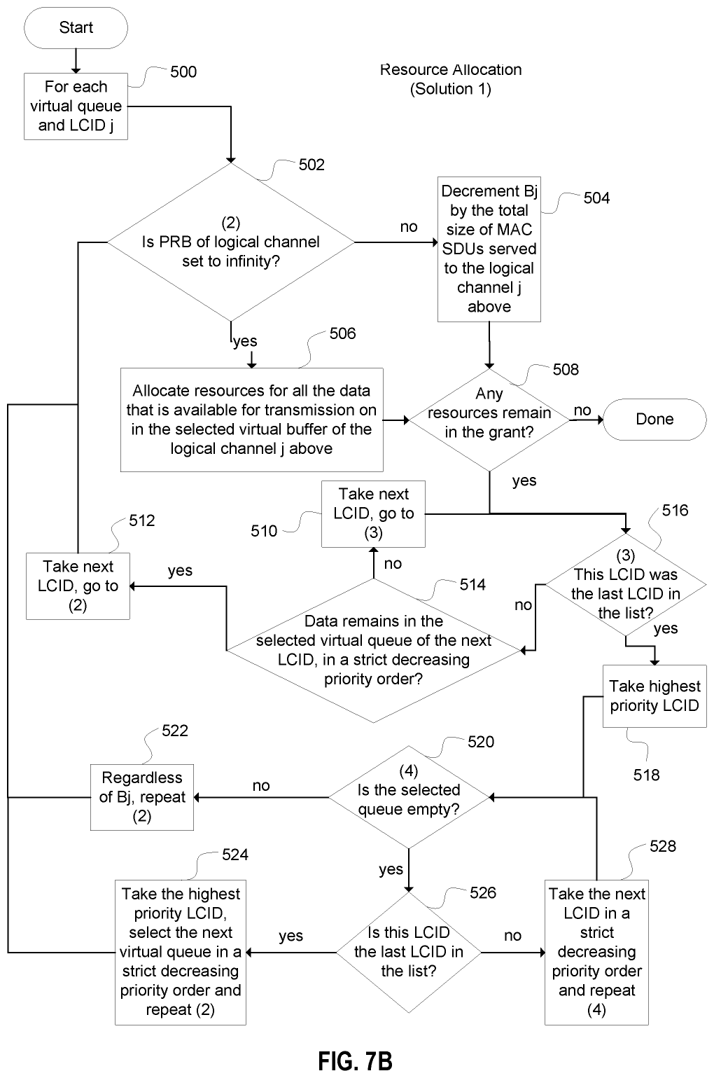

FIG. 7A shows two LCIDs; in each of them there are 3 virtual buffers. In one virtual buffer, all packets in a given LCID with a PDB_left of equal to or less than 5 ms will be queued. A second virtual buffer will contain all packets in a given LCID with a PDB_left larger than 5 ms and equal to or less than 10 ms. The third virtual buffer will queue all packets in a given LCID with PDB_left larger than 10 ms. The number of virtual buffers and the thresholds are configured by the network. Packets within a LCID will be moved by the UE from one virtual queue to another depending on the PDB_left for the given packet.

### Solution 1: (LCIDs Configured)

If the UE has been configured to use delay-aware scheduling, when the UE has a grant, the UE selects the LCIDs, if they are configured, and allocates resources as shown in FIG. 7B and as follows.

The selection of a logical channel is based on the fulfillment of all the following conditions: (i) same conditions as legacy; and (ii) if the transmission timing indicated in the associated grant is feasible for any value of PDB_left in the corresponding LCID, e.g., remaining time for transmission or successful reception of corresponding PUSCH is less than of any values of PDB_left (this can be configured by a new IE).

Above, new iEs can be controlled by RRC for introducing additional mapping restrictions for each logical channel for delay-aware scheduling. And the grant type of delay-aware scheduling and information for grant timing are included in uplink transmission information received from lower layers for the corresponding scheduled uplink transmission.

More particularly, as shown in FIG. 7B, the allocation of the resources is performed as follows.

The selected logical channels for the UL grant with Bj>0 are allocated resources in a decreasing priority order. The highest priority LCID is served first. If multiple LCIDs have similar priority, the UE selects the LCID that has the least bits in the highest priority virtual queue. Logical channels are served until there is no data in all (virtual) buffers or the UL grant is exhausted. The highest priority virtual queue is selected first for all LCIDs. Logical channels configured with equal priority should be served equally.

For the given virtual queue and LCID j (Block 500), (2) If PRB of a logical channel is not set to infinity (NO at Block 502), decrement Bj by the total size of MAC SDUs served to the logical channel j above (Block 504). Else, (YES at Block 502), allocate resources for all the data that is available for transmission on in the selected virtual buffer of the logical channel j above (Block 506).

If any resources remain in the grant (YES at Block 508), the UE performs the following. (3) If this LCID was not the last LCID in the list (NO at Block 516), and data remains in the selected virtual queue of the next LCID (in a strict decreasing priority order) (YES at Block 514), the UE takes the next LCID and repeats (2) (Block 512). Else, if this LCID was not the last LCID in the list (YES at Block 516), but no data remains in the selected virtual queue of the next LCID (in a strict decreasing priority order) (NO at Block 514), the UE takes the next LCID and repeat (3) (Block 510).

Else, if this LCID was the last LCID in the list (YES at Block 516), the UE takes the highest priority LCID (Block 518). (4) If the selected virtual queue is not empty (NO at Block 520), regardless of Bj, the UE repeats (2). Else, if the selected virtual queue is empty (YES at Block 520), and this LCID was not the last LCID in the list (NO at Bock 526), the UE takes the next LCID in a strict decreasing priority order and repeats (4) (Block 528). Else, if the selected virtual queue is empty (YES at Block 520), but this LCID was the last LCID in the list (YES at Bock 526), the UE takes the highest priority LCID, selects the next virtual queue in a strict decreasing priority order, and repeats (2) (Block 524).

Bj is a variable used and maintained for logical channel j. A variable is maintained for each logical channel. Thus, PRB and BSD is provided for each logical channel (as in legacy).

Alternatively, Bi,j is used and maintained for each virtual buffer in each LCID, where i represents the virtual buffer and j the logical channel. In this latter case, PRB and BSD could be identical for each virtual buffer in each LCID. Another option is that PRB and/or BSD is provided for each virtual buffer in each LCID. This allows for finer differentiation between virtual buffer in one logical channel and also among logical channels.

In these embodiments where Bi,j is used, Bi,j is initialized to zero when the logical channel is established. For each logical channel, Bi,j is incremented by the product (PBRi,j×T) before every instance of the LCP procedure, where T is the time elapsed since Bi,j was last incremented. if the value of Bi,j is greater than the bucket size (i.e. PBRi,j×BSDi,j), the UE sets Bi,j to the bucket size.

### Solution 2: (No LCIDs Configured)

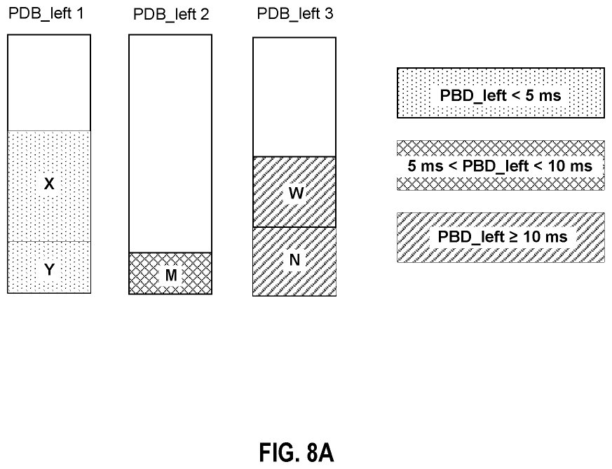

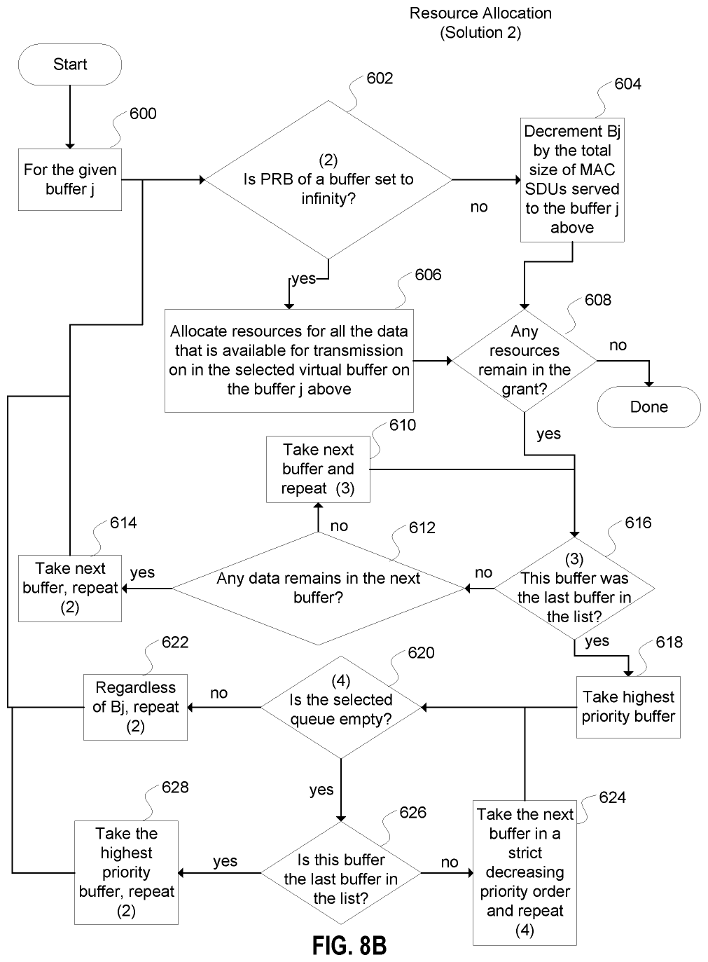

In other embodiments, LCIDs are not configured. If LCIDs are not configured, then a packet is queued in a buffer defined by minimum and maximum time thresholds. FIG. 8A shows 3 buffers. In one buffer, all packets with a PDB_left of equal to or less than 5 ms will be queued. A second buffer will contain all packets with a PDB_left larger than 5 ms and equal to or less than 10 ms. The third buffer will queue all packets with PDB_left larger than 10 ms. The number of buffers and the thresholds are configured by the network. Packets will be moved by the UE from one buffer to another depending on the PDB_left for the given packet.

If the UE has been configured to use delay-aware scheduling and LCIDs have not been configured, when the UE has a grant, the UE allocates resources as shown in FIG. 8B and as follows.

The selection of the buffers is based on the fulfillment of all the following conditions: (i) same conditions as legacy but restricted for each buffer with a different PDB_left; and (ii) if the transmission timing indicated in the associated grant is feasible for any value of PDB_left in the corresponding buffer, e.g., remaining time for transmission or successful reception of corresponding PUSCH is less than of any values of PDB_left. This can be configured by a new IE. Above, new iEs can be controlled by RRC for introducing additional mapping restrictions for each buffer for delay-aware scheduling, and the grant type of delay-aware scheduling and information for grant timing are included in uplink transmission information received from lower layers for the corresponding scheduled uplink transmission.

The allocation of the resources is performed as follows. The selected buffers for the UL grant with Bj>0 are allocated resources in a decreasing priority order. The highest priority buffer is served first. Buffers are served until there is no data in all buffers or the UL grant is exhausted. Buffers configured with equal priority should be served equally.

For the given buffer j (Block 600), (2) if the PRB of a buffer is not set to infinity (NO at Block 602), the UE decrements Bj by the total size of MAC SDUs served to the buffer j above (Block 604). Else (YES at Block 606), the UE allocates resources for all the data that is available for transmission on the buffer j above (Block 606).

If any resources remain (YES at Block 608), the UE performs the following. (3) If this buffer was not the last buffer in the list (NO at Block 616), and if data remains in the next buffer (in a strict decreasing priority order) (YES at Block 612), the UE takes the next buffer and repeats (2) (Block 614). Else, if this buffer was not the last buffer in the list (NO at Block 616), but no data remains in the next buffer (in a strict decreasing priority order) (NO at Block 612), the UE takes the next buffer and repeats (3) (Block 610).

Else, if this buffer was the last buffer in the list (YES at Block 616), the UE takes the highest priority buffer (Block 618). (4) If the selected buffer is not empty (NO at Block 622), the UE, regardless of Bj, repeats (2) (Block 622). Else, if the selected buffer is empty (YES at Block 622), and if this buffer was not the last buffer in the list (NO at Block 626), the UE takes the next buffer in a strict decreasing priority order and repeats (4) (Block 624). Otherwise, if the selected buffer is empty (YES at Block 622), but this buffer was the last buffer in the list (YES at Block 626), the UE takes the highest priority buffer and repeats (2) (Block 628).

Bj is a variable used and maintained for each buffer. Thus, PRB and BSD is provided for each buffer.

Bj is initialized to zero when the buffer is established. For each buffer, Bj is incremented by the product (PBRj×T) before every instance of the LCP procedure, where T is the time elapsed since Bj was last incremented. If the value of Bj is greater than the bucket size (i.e. PBRj×BSDj), the UE sets Bj to the bucket size.

Solution 3: (LCIDs Configured with Single PDB Left)

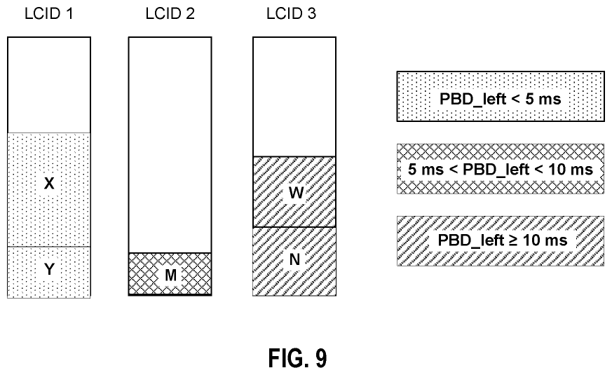

In another solution, each LCID is configured with a single PDB_left value whose mapping is controlled by RRC and the traditional LCID prioritization procedure is applied based on legacy conditions or legacy and new iEs for delay-aware scheduling. See FIG. 9. In this case, a virtual buffer is not needed. A different LCID is defined based on the PDB_left value. Higher priority LCID is assigned with shorter PDB_left value. The allocation of resource is also followed as a legacy method.

Note that a packet herein can be, but is not limited to, an IP packet, a Service Data Adaptation Protocol (SDAP) SDU/PDU, a Packet Data Convergence Protocol (PDCP) SDU/PDU, or an application data unit (ADU), for instance.

It is to be noted that, depending how PDB is measured and from which two points are taken as reference, timing information may be needed to calculate the PDB_left. PDB_left is the remaining time within which the packet should be delivered to the second point. For example, if PDB is provided end-to-end, the RAN needs to have timing related information that assists the RAN to calculate the PDB_left as the maximum time the RAN has to deliver that packet to the second point. In this example, the PDB_left would be: PDB (end-to-end)-elapsed time until packet reached RAN. If PDB is measured from the point where the packet enters the RAN until it is delivered to higher layers in the receiver side, then the RAN does not require additional timing related information. Even if PDB_left has been used throughout the description herein, timing information could also be the queued time in the buffer i.e., the elapsed time since the packet entered the queue.

Buffer and queue are used inter-changeably herein.

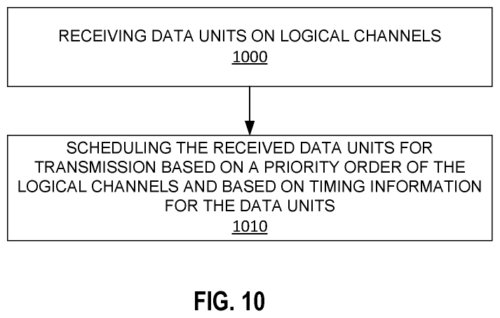

In view of the modifications and variations herein, FIG. 10 depicts a method performed by a communication device 12. The method comprises receiving data units D on logical channels 18 (Block 1000). The method also comprises scheduling the received data units D for transmission based on a priority order of the logical channels 18 and based on timing information T for the data units D (Block 1010).

In some embodiments, for example, the timing information T includes, for each data unit D, a time budget remaining for the data unit D to meet a timing requirement.

In some embodiments, the data units D are packets, the timing requirement for a packet is a packet delay budget, and the time budget remaining for a packet comprises an amount of time left before the packet must be delivered to a reference point in order to meet the packet delay budget for the packet.

In some embodiments, the method further comprises associating each data unit D with a priority P1, P2, P3 based on the time budget remaining for the data unit. In one such embodiment, where a data unit D is associated with a higher priority the smaller the time budget remaining for the data unit, said scheduling comprises scheduling the data units for transmission based on the priority order of the logical channels 18 and based on the priorities P1, P2, P3 associated with the data units D.

In one embodiment, this associating comprises associating each data unit with one of multiple possible priorities P1, P2, P3 based on within which one of multiple time budget ranges the time budget remaining for the data unit belongs.

In another embodiment, this associating comprises storing each data unit D in a virtual queue based on the time budget remaining for the data unit, where each virtual queue has a priority P1, P2, P3, and each data unit is associated with the priority of the virtual queue within which the data unit is stored. In one such embodiment, said scheduling comprises allocating transmission resources to the logical channels 18 in a decreasing priority order, with transmission resources being allocated for a highest priority virtual queue first for all logical channels. In another such embodiment, said scheduling comprises allocating transmission resources to the logical channels in a decreasing priority order, with transmission resources being allocated for transmission of all data units stored in a higher priority virtual queue before transmission resources are allocated for transmission of any data units stored in a lower priority virtual queue. Regardless, in some embodiments, said scheduling comprises selecting logical channels to which to allocate transmission resources based on a variable computed per logical channel and per virtual queue, where the variable is computed as a function of a prioritized bit rate per logical channel and per virtual queue and as a function of a bucket size duration per logical channel and per virtual queue.

In yet another embodiment, said scheduling comprises allocating transmission resources to the logical channels in a decreasing priority order, with transmission resources being allocated for transmission of all data units associated with a higher priority before transmission resources are allocated for transmission of any data units associated with a lower priority.

In some embodiments, the method further comprises storing the received data units D in buffers at the communication device 12 respectively associated with the logical channels 18 on which the data units D are received. In some embodiments, the timing information T for the data units D includes, for each data unit D, an amount of time that the data unit D has been stored in one of the buffers.

In some embodiments, receiving the data units D comprises receiving the data units D on logical channels 18 at a medium access control (MAC) layer of the communication device 12 or at a MAC entity of the communication device 12.

In some embodiments, the data units D are medium access control (MAC) service data units (SDUs).

In some embodiments, said scheduling comprises allocating transmission resources for transmission of the data units D. In this case, the transmission resources correspond to available spaces in a data block to be transmitted during a transmission time interval at the communication device 12.

In some embodiments, the method further comprises receiving, from a network node 14, signaling indicating one or more of: one or more thresholds governing prioritization for scheduling data units D for transmission based on timing information T for data units D, how many virtual queues data units are to be stored across according to timing information T for the data units, a prioritized bit rate per logical channel and per virtual queue buffer, or a bucket size duration per logical channel and per virtual queue

In some embodiments, said scheduling comprises allocating transmission resources to the logical channels 18 based on the priority order of the logical channels and based on the timing information T for the data units D.

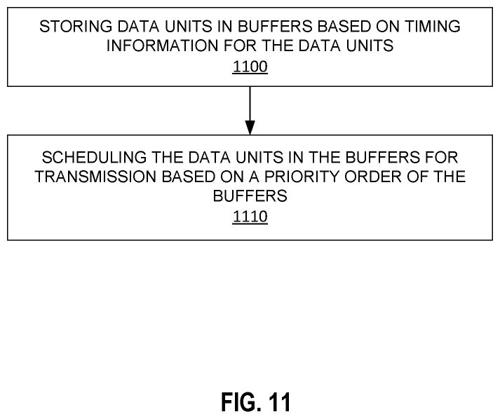

FIG. 11 shows a method performed by a communication device according to other embodiments. The method comprises storing data units in buffers based on timing information for the data units (Block 1100). The method also comprises scheduling the data units in the buffers for transmission based on a priority order of the buffers (Block 1110).

In some embodiments, the timing information includes, for each data unit, a time budget remaining for the data unit to meet a timing requirement. In one or more of these embodiments, the data units are packets, the timing requirement for a packet is a packet delay budget, and the time budget remaining for a packet comprises an amount of time left before the packet must be delivered to a reference point in order to meet the packet delay budget for the packet. In one or more of these embodiments, different buffers are for different respective ranges of time budgets remaining. In some embodiments, a buffer for a range of smaller time budgets remaining is prioritized in the priority order higher than a buffer for a range of larger time budgets remaining. In one or more of these embodiments, said storing comprises, for each data unit, determining which one of the ranges a time budget remaining for the data unit is included and storing the data unit in the buffer that is for the determined range.

In some embodiments, said scheduling comprises allocating transmission resources for transmission of data units in the buffers in a decreasing priority order of the buffers.

In some embodiments, said scheduling comprises allocating transmission resources for transmission of data units in the buffers in a decreasing priority order of the buffers, with transmission resources being allocated for transmission of all data units stored in a higher priority buffer before transmission resources are allocated for transmission of any data units stored in a lower priority buffer. In one or more of these embodiments, said scheduling comprises selecting buffers to which to allocate transmission resources based on a variable computed per buffer. In some embodiments, the variable is computed as a function of a prioritized bit rate per buffer. In some embodiments, the variable is computed as a bucket size duration per buffer.

In some embodiments, the timing information for the data units includes, for each data unit, an amount of time that the data unit has been stored in one of the buffers.

In some embodiments, the data units are received at a medium access control (MAC) layer of the communication device or at a MAC entity of the communication device.

In some embodiments, the data units are medium access control (MAC) service data units (SDUs).

In some embodiments, said scheduling comprises allocating transmission resources for transmission of the data units. In this case, the transmission resources correspond to available spaces in a data block to be transmitted during a transmission time interval at the communication device.

In some embodiments, the method further comprises receiving, from a network node, signaling indicating one or more of one or more thresholds governing prioritization for scheduling the data units for transmission based on timing information for data units, a prioritized bit rate per buffer, or a bucket size duration per buffer

In some embodiments, said scheduling comprises allocating transmission resources for transmission of the data units in the buffers based on a priority order of the buffers.

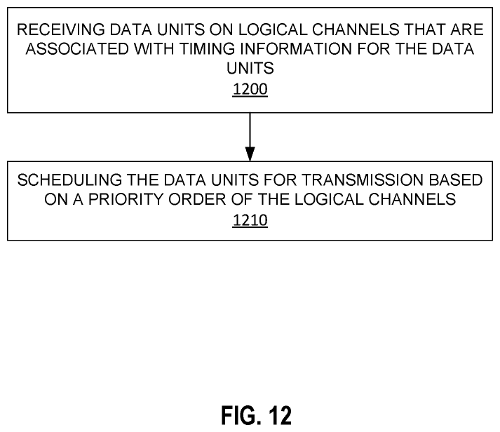

FIG. 12 shows a method performed by a communication device according to still other embodiments. The method comprises receiving data units on logical channels that are associated with timing information for the data units (Block 12). The method also comprises scheduling the data units for transmission based on a priority order of the logical channels (Block 1210).

In some embodiments, the timing information includes, for each data unit, a time budget remaining for the data unit to meet a timing requirement. In one or more of these embodiments, the data units are packets, the timing requirement for a packet is a packet delay budget, and the time budget remaining for a packet comprises an amount of time left before the packet must be delivered to a reference point in order to meet the packet delay budget for the packet. In one or more of these embodiments, each data unit is received on a logical channel that is associated with the time budget remaining for the data unit. In one or more of these embodiments, different ones of the logical channels are associated with different respective time budget ranges remaining for the data units.

In some embodiments, receiving the data units comprises receiving the data units on logical channels at a medium access control (MAC) layer of the communication device or at a MAC entity of the communication device.

In some embodiments, the data units are medium access control (MAC) service data units (SDUs).

In some embodiments, said scheduling comprises allocating transmission resources for transmission of the data units. In this case, the transmission resources correspond to available spaces in a data block to be transmitted during a transmission time interval at the communication device.

In some embodiments, said scheduling comprises selecting which logical channels to allocate transmission resources and allocating transmission resources to the selected logical channels in a decreasing priority order.

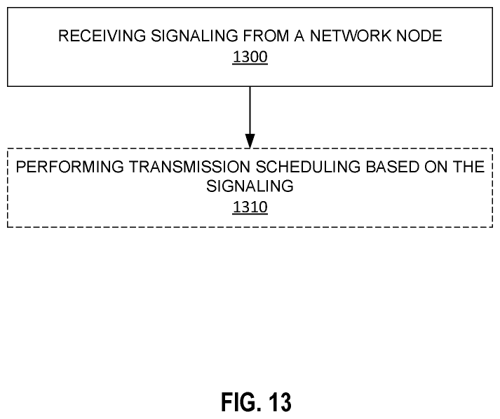

FIG. 13 shows a method performed by a communication device according to yet other embodiments. The method comprises receiving signaling from a network node 14 (Block 1300). In some embodiments, the signaling indicates one or more of: one or more thresholds governing prioritization for performing transmission scheduling based on timing information T for data units D, how many virtual queues data units D are to be stored across according to timing information T for the data units D, a prioritized bit rate per logical channel and per virtual queue or a prioritized bit rate per buffer, or a bucket size duration per logical channel and per virtual queue or a bucket size duration per buffer.

In some embodiments, the method further comprises performing transmission scheduling based on the signaling (Block 1310).

In some embodiments, the one or more thresholds comprise one or more time budget remaining thresholds governing definition of time budget ranges at the communication device.

In this case, the time budget ranges are associated with respective priorities at the communication device.

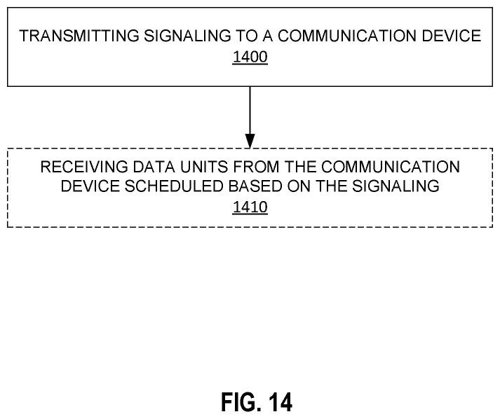

FIG. 14 shows a method performed by a network node configured for use in a communication network according to some embodiments. The method comprises transmitting signaling to a communication device (Block 1400). In some embodiments, the signaling indicates one or more of: one or more thresholds governing prioritization according to which the communication device 12 is to perform transmission scheduling based on timing information T for data units D, how many virtual queues data units are to be stored across by the communication device 12 according to timing information T for the data units D, a prioritized bit rate per logical channel and per virtual queue or a prioritized bit rate per buffer, or a bucket size duration per logical channel and per virtual queue or a bucket size duration per buffer.

In some embodiments, the method further comprises receiving data units D from the communication device 12 scheduled based on the signaling (Block 1410).

In some embodiments, the one or more thresholds comprise one or more time budget remaining thresholds governing definition of time budget ranges at the communication device. In some embodiments, the time budget ranges are associated with respective priorities at the communication device 12.

Embodiments herein also include corresponding apparatuses. Embodiments herein for instance include a communication device 12 configured to perform any of the steps of any of the embodiments described above for the communication device 12.

Embodiments also include a communication device 12 comprising processing circuitry and power supply circuitry. The processing circuitry is configured to perform any of the steps of any of the embodiments described above for the communication device 12. The power supply circuitry is configured to supply power to the communication device 12.

Embodiments further include a communication device 12 comprising processing circuitry. The processing circuitry is configured to perform any of the steps of any of the embodiments described above for the communication device 12. In some embodiments, the communication device 12 further comprises communication circuitry.

Embodiments further include a communication device 12 comprising processing circuitry and memory. The memory contains instructions executable by the processing circuitry whereby the communication device 12 is configured to perform any of the steps of any of the embodiments described above for the communication device 12.

Embodiments moreover include a user equipment (UE). The UE comprises an antenna configured to send and receive wireless signals. The UE also comprises radio front-end circuitry connected to the antenna and to processing circuitry, and configured to condition signals communicated between the antenna and the processing circuitry. The processing circuitry is configured to perform any of the steps of any of the embodiments described above for the communication device 12. In some embodiments, the UE also comprises an input interface connected to the processing circuitry and configured to allow input of information into the UE to be processed by the processing circuitry. The UE may comprise an output interface connected to the processing circuitry and configured to output information from the UE that has been processed by the processing circuitry. The UE may also comprise a battery connected to the processing circuitry and configured to supply power to the UE.

Embodiments herein also include a network node 14 configured to perform any of the steps of any of the embodiments described above for the network node 14.

Embodiments also include a network node 14 comprising processing circuitry and power supply circuitry. The processing circuitry is configured to perform any of the steps of any of the embodiments described above for the network node 14. The power supply circuitry is configured to supply power to the network node 14.

Embodiments further include a network node 14 comprising processing circuitry. The processing circuitry is configured to perform any of the steps of any of the embodiments described above for the network node 14. In some embodiments, the network node 14 further comprises communication circuitry.

Embodiments further include a network node 14 comprising processing circuitry and memory. The memory contains instructions executable by the processing circuitry whereby the network node 14 is configured to perform any of the steps of any of the embodiments described above for the network node 14.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

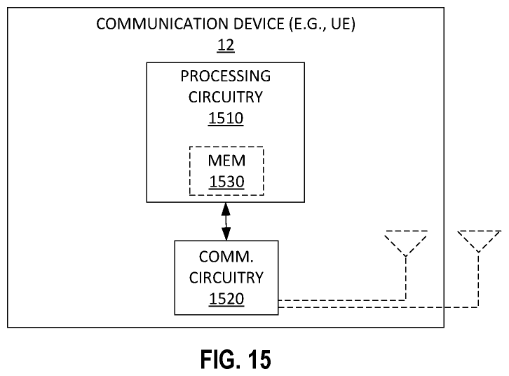

FIG. 15 for example illustrates a communication device 12 as implemented in accordance with one or more embodiments. As shown, the communication device 12 includes processing circuitry 1510 and communication circuitry 1520. The communication circuitry 1520 (e.g., radio circuitry) is configured to transmit and/or receive information to and/or from one or more other nodes, e.g., via any communication technology. Such communication may occur via one or more antennas that are either internal or external to the communication device 12. The processing circuitry 1510 is configured to perform processing described above, e.g., in any of FIGS. 10-13, such as by executing instructions stored in memory 1530. The processing circuitry 1510 in this regard may implement certain functional means, units, or modules.

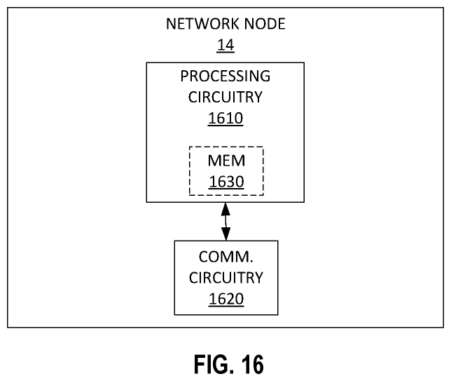

FIG. 16 illustrates a network node 14 as implemented in accordance with one or more embodiments. As shown, the network node 14 includes processing circuitry 1610 and communication circuitry 1620. The communication circuitry 1620 is configured to transmit and/or receive information to and/or from one or more other nodes, e.g., via any communication technology. The processing circuitry 1610 is configured to perform processing described above, e.g., in FIG. 14, such as by executing instructions stored in memory 1630. The processing circuitry 1610 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

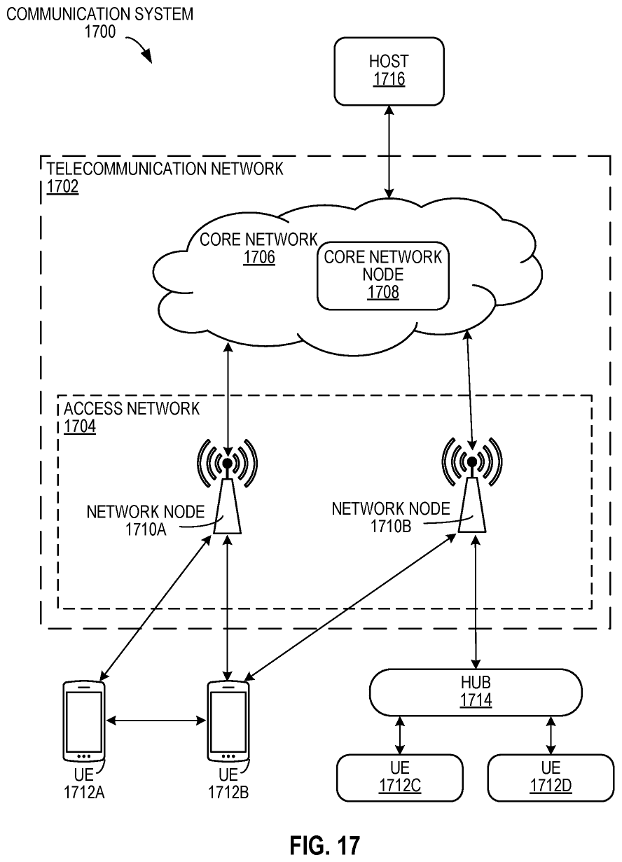

FIG. 17 shows an example of a communication system 1700 in accordance with some embodiments.

In the example, the communication system 1700 includes a telecommunication network 1702 that includes an access network 1704, such as a radio access network (RAN), and a core network 1706, which includes one or more core network nodes 1708. The access network 1704 includes one or more access network nodes, such as network nodes 1710a and 1710b (one or more of which may be generally referred to as network nodes 1710), or any other similar 3rd Generation Partnership Project (3GPP) access node or non-3GPP access point. The network nodes 1710 facilitate direct or indirect connection of user equipment (UE), such as by connecting UEs 1712a, 1712b, 1712c, and 1712d (one or more of which may be generally referred to as UEs 1712) to the core network 1706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1700 may include any number of wired or wireless networks, network nodes, UEs, and/or any other components or systems that may facilitate or participate in the communication of data and/or signals whether via wired or wireless connections. The communication system 1700 may include and/or interface with any type of communication, telecommunication, data, cellular, radio network, and/or other similar type of system.

The UEs 1712 may be any of a wide variety of communication devices, including wireless devices arranged, configured, and/or operable to communicate wirelessly with the network nodes 1710 and other communication devices. Similarly, the network nodes 1710 are arranged, capable, configured, and/or operable to communicate directly or indirectly with the UEs 1712 and/or with other network nodes or equipment in the telecommunication network 1702 to enable and/or provide network access, such as wireless network access, and/or to perform other functions, such as administration in the telecommunication network 1702.

In the depicted example, the core network 1706 connects the network nodes 1710 to one or more hosts, such as host 1716. These connections may be direct or indirect via one or more intermediary networks or devices. In other examples, network nodes may be directly coupled to hosts. The core network 1706 includes one more core network nodes (e.g., core network node 1708) that are structured with hardware and software components. Features of these components may be substantially similar to those described with respect to the UEs, network nodes, and/or hosts, such that the descriptions thereof are generally applicable to the corresponding components of the core network node 1708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1716 may be under the ownership or control of a service provider other than an operator or provider of the access network 1704 and/or the telecommunication network 1702, and may be operated by the service provider or on behalf of the service provider. The host 1716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1700 of FIG. 17 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1702 is a cellular network that implements 3GPP standardized features. Accordingly, the telecommunications network 1702 may support network slicing to provide different logical networks to different devices that are connected to the telecommunication network 1702. For example, the telecommunications network 1702 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1712 are configured to transmit and/or receive information without direct human interaction. For instance, a UE may be designed to transmit information to the access network 1704 on a predetermined schedule, when triggered by an internal or external event, or in response to requests from the access network 1704. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub 1714 communicates with the access network 1704 to facilitate indirect communication between one or more UEs (e.g., UE 1712c and/or 1712d) and network nodes (e.g., network node 1710b). In some examples, the hub 1714 may be a controller, router, content source and analytics, or any of the other communication devices described herein regarding UEs. For example, the hub 1714 may be a broadband router enabling access to the core network 1706 for the UEs. As another example, the hub 1714 may be a controller that sends commands or instructions to one or more actuators in the UEs. Commands or instructions may be received from the UEs, network nodes 1710, or by executable code, script, process, or other instructions in the hub 1714. As another example, the hub 1714 may be a data collector that acts as temporary storage for UE data and, in some embodiments, may perform analysis or other processing of the data. As another example, the hub 1714 may be a content source. For example, for a UE that is a VR headset, display, loudspeaker or other media delivery device, the hub 1714 may retrieve VR assets, video, audio, or other media or data related to sensory information via a network node, which the hub 1714 then provides to the UE either directly, after performing local processing, and/or after adding additional local content. In still another example, the hub 1714 acts as a proxy server or orchestrator for the UEs, in particular in if one or more of the UEs are low energy IoT devices.

The hub 1714 may have a constant/persistent or intermittent connection to the network node 1710b. The hub 1714 may also allow for a different communication scheme and/or schedule between the hub 1714 and UEs (e.g., UE 1712c and/or 1712d), and between the hub 1714 and the core network 1706. In other examples, the hub 1714 is connected to the core network 1706 and/or one or more UEs via a wired connection. Moreover, the hub 1714 may be configured to connect to an M2M service provider over the access network 1704 and/or to another UE over a direct connection. In some scenarios, UEs may establish a wireless connection with the network nodes 1710 while still connected via the hub 1714 via a wired or wireless connection. In some embodiments, the hub 1714 may be a dedicated hub—that is, a hub whose primary function is to route communications to/from the UEs from/to the network node 1710b. In other embodiments, the hub 1714 may be a non-dedicated hub—that is, a device which is capable of operating to route communications between the UEs and network node 1710b, but which is additionally capable of operating as a communication start and/or end point for certain data channels.

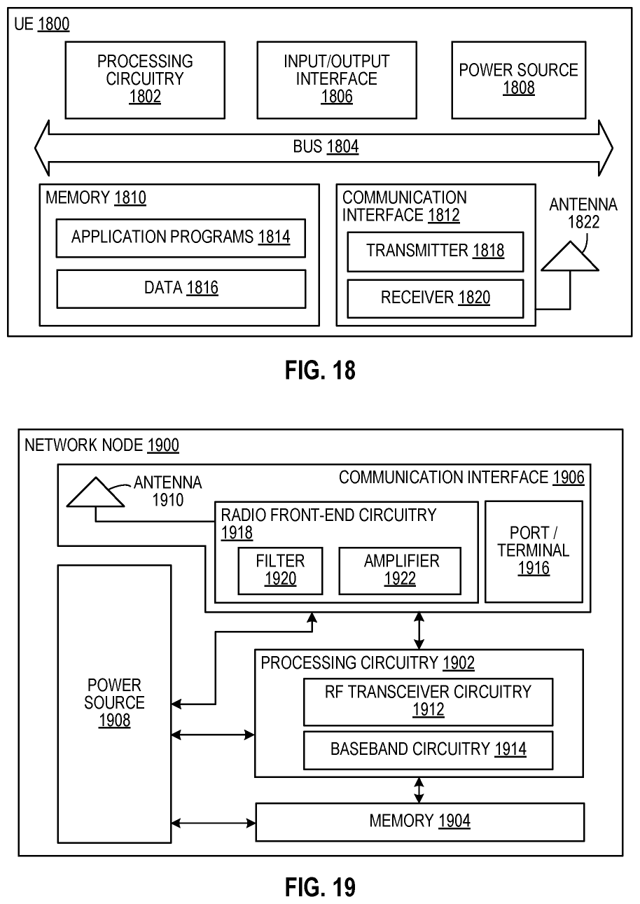

FIG. 18 shows a UE 1800 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1800 includes processing circuitry 1802 that is operatively coupled via a bus 1804 to an input/output interface 1806, a power source 1808, a memory 1810, a communication interface 1812, and/or any other component, or any combination thereof. Certain UEs may utilize all or a subset of the components shown in FIG. 18. The level of integration between the components may vary from one UE to another UE. Further, certain UEs may contain multiple instances of a component, such as multiple processors, memories, transceivers, transmitters, receivers, etc.

The processing circuitry 1802 is configured to process instructions and data and may be configured to implement any sequential state machine operative to execute instructions stored as machine-readable computer programs in the memory 1810. The processing circuitry 1802 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1802 may include multiple central processing units (CPUs).

In the example, the input/output interface 1806 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1800. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1808 is structured as a battery or battery pack. Other types of power sources, such as an external power source (e.g., an electricity outlet), photovoltaic device, or power cell, may be used. The power source 1808 may further include power circuitry for delivering power from the power source 1808 itself, and/or an external power source, to the various parts of the UE 1800 via input circuitry or an interface such as an electrical power cable. Delivering power may be, for example, for charging of the power source 1808. Power circuitry may perform any formatting, converting, or other modification to the power from the power source 1808 to make the power suitable for the respective components of the UE 1800 to which power is supplied.

The memory 1810 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1810 includes one or more application programs 1814, such as an operating system, web browser application, a widget, gadget engine, or other application, and corresponding data 1816. The memory 1810 may store, for use by the UE 1800, any of a variety of various operating systems or combinations of operating systems.

The memory 1810 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1810 may allow the UE 1800 to access instructions, application programs and the like, stored on transitory or non-transitory memory media, to off-load data, or to upload data. An article of manufacture, such as one utilizing a communication system may be tangibly embodied as or in the memory 1810, which may be or comprise a device-readable storage medium.

The processing circuitry 1802 may be configured to communicate with an access network or other network using the communication interface 1812. The communication interface 1812 may comprise one or more communication subsystems and may include or be communicatively coupled to an antenna 1822. The communication interface 1812 may include one or more transceivers used to communicate, such as by communicating with one or more remote transceivers of another device capable of wireless communication (e.g., another UE or a network node in an access network). Each transceiver may include a transmitter 1818 and/or a receiver 1820 appropriate to provide network communications (e.g., optical, electrical, frequency allocations, and so forth). Moreover, the transmitter 1818 and receiver 1820 may be coupled to one or more antennas (e.g., antenna 1822) and may share circuit components, software or firmware, or alternatively be implemented separately.

In the illustrated embodiment, communication functions of the communication interface 1812 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1812, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1800 shown in FIG. 18.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 19 shows a network node 1900 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1900 includes a processing circuitry 1902, a memory 1904, a communication interface 1906, and a power source 1908. The network node 1900 may be composed of multiple physically separate components (e.g., a NodeB component and a RNC component, or a BTS component and a BSC component, etc.), which may each have their own respective components. In certain scenarios in which the network node 1900 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1900 may be configured to support multiple radio access technologies (RATs). In such embodiments, some components may be duplicated (e.g., separate memory 1904 for different RATs) and some components may be reused (e.g., a same antenna 1910 may be shared by different RATs). The network node 1900 may also include multiple sets of the various illustrated components for different wireless technologies integrated into network node 1900, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1900.

The processing circuitry 1902 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1900 components, such as the memory 1904, to provide network node 1900 functionality.

In some embodiments, the processing circuitry 1902 includes a system on a chip (SOC). In some embodiments, the processing circuitry 1902 includes one or more of radio frequency (RF) transceiver circuitry 1912 and baseband processing circuitry 1914. In some embodiments, the radio frequency (RF) transceiver circuitry 1912 and the baseband processing circuitry 1914 may be on separate chips (or sets of chips), boards, or units, such as radio units and digital units. In alternative embodiments, part or all of RF transceiver circuitry 1912 and baseband processing circuitry 1914 may be on the same chip or set of chips, boards, or units.

The memory 1904 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1902. The memory 1904 may store any suitable instructions, data, or information, including a computer program, software, an application including one or more of logic, rules, code, tables, and/or other instructions capable of being executed by the processing circuitry 1902 and utilized by the network node 1900. The memory 1904 may be used to store any calculations made by the processing circuitry 1902 and/or any data received via the communication interface 1906. In some embodiments, the processing circuitry 1902 and memory 1904 is integrated.

The communication interface 1906 is used in wired or wireless communication of signaling and/or data between a network node, access network, and/or UE. As illustrated, the communication interface 1906 comprises port(s)/terminal(s) 1916 to send and receive data, for example to and from a network over a wired connection. The communication interface 1906 also includes radio front-end circuitry 1918 that may be coupled to, or in certain embodiments a part of, the antenna 1910. Radio front-end circuitry 1918 comprises filters 1920 and amplifiers 1922. The radio front-end circuitry 1918 may be connected to an antenna 1910 and processing circuitry 1902. The radio front-end circuitry may be configured to condition signals communicated between antenna 1910 and processing circuitry 1902. The radio front-end circuitry 1918 may receive digital data that is to be sent out to other network nodes or UEs via a wireless connection. The radio front-end circuitry 1918 may convert the digital data into a radio signal having the appropriate channel and bandwidth parameters using a combination of filters 1920 and/or amplifiers 1922. The radio signal may then be transmitted via the antenna 1910. Similarly, when receiving data, the antenna 1910 may collect radio signals which are then converted into digital data by the radio front-end circuitry 1918. The digital data may be passed to the processing circuitry 1902. In other embodiments, the communication interface may comprise different components and/or different combinations of components.

In certain alternative embodiments, the network node 1900 does not include separate radio front-end circuitry 1918, instead, the processing circuitry 1902 includes radio front-end circuitry and is connected to the antenna 1910. Similarly, in some embodiments, all or some of the RF transceiver circuitry 1912 is part of the communication interface 1906. In still other embodiments, the communication interface 1906 includes one or more ports or terminals 1916, the radio front-end circuitry 1918, and the RF transceiver circuitry 1912, as part of a radio unit (not shown), and the communication interface 1906 communicates with the baseband processing circuitry 1914, which is part of a digital unit (not shown).

The antenna 1910 may include one or more antennas, or antenna arrays, configured to send and/or receive wireless signals. The antenna 1910 may be coupled to the radio front-end circuitry 1918 and may be any type of antenna capable of transmitting and receiving data and/or signals wirelessly. In certain embodiments, the antenna 1910 is separate from the network node 1900 and connectable to the network node 1900 through an interface or port.

The antenna 1910, communication interface 1906, and/or the processing circuitry 1902 may be configured to perform any receiving operations and/or certain obtaining operations described herein as being performed by the network node. Any information, data and/or signals may be received from a UE, another network node and/or any other network equipment. Similarly, the antenna 1910, the communication interface 1906, and/or the processing circuitry 1902 may be configured to perform any transmitting operations described herein as being performed by the network node. Any information, data and/or signals may be transmitted to a UE, another network node and/or any other network equipment.

The power source 1908 provides power to the various components of network node 1900 in a form suitable for the respective components (e.g., at a voltage and current level needed for each respective component). The power source 1908 may further comprise, or be coupled to, power management circuitry to supply the components of the network node 1900 with power for performing the functionality described herein. For example, the network node 1900 may be connectable to an external power source (e.g., the power grid, an electricity outlet) via an input circuitry or interface such as an electrical cable, whereby the external power source supplies power to power circuitry of the power source 1908. As a further example, the power source 1908 may comprise a source of power in the form of a battery or battery pack which is connected to, or integrated in, power circuitry. The battery may provide backup power should the external power source fail.

Embodiments of the network node 1900 may include additional components beyond those shown in FIG. 19 for providing certain aspects of the network node's functionality, including any of the functionality described herein and/or any functionality necessary to support the subject matter described herein. For example, the network node 1900 may include user interface equipment to allow input of information into the network node 1900 and to allow output of information from the network node 1900. This may allow a user to perform diagnostic, maintenance, repair, and other administrative functions for the network node 1900.

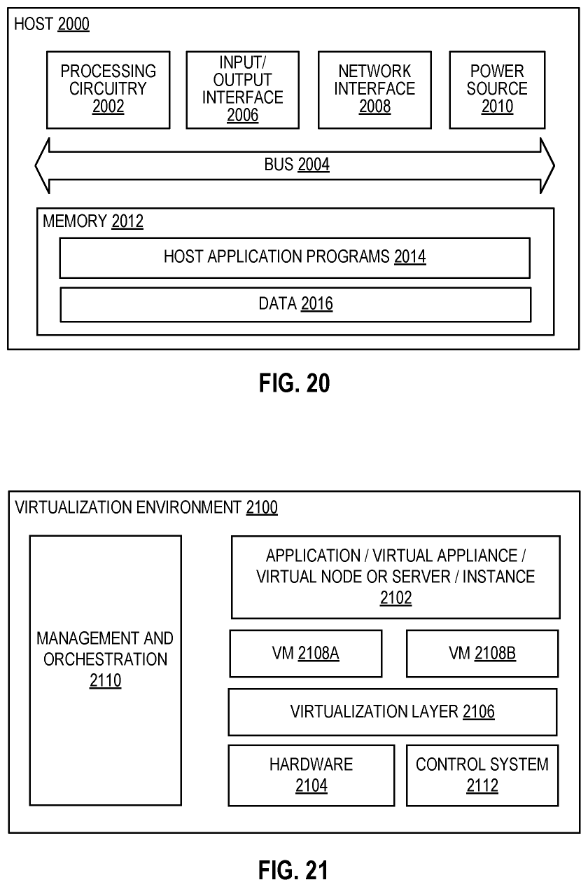

FIG. 20 is a block diagram of a host 2000, which may be an embodiment of the host 1716 of FIG. 17, in accordance with various aspects described herein. As used herein, the host 2000 may be or comprise various combinations hardware and/or software, including a standalone server, a blade server, a cloud-implemented server, a distributed server, a virtual machine, container, or processing resources in a server farm. The host 2000 may provide one or more services to one or more UEs.

The host 2000 includes processing circuitry 2002 that is operatively coupled via a bus 2004 to an input/output interface 2006, a network interface 2008, a power source 2010, and a memory 2012. Other components may be included in other embodiments. Features of these components may be substantially similar to those described with respect to the devices of previous figures, such as FIGS. 18 and 19, such that the descriptions thereof are generally applicable to the corresponding components of host 2000.

The memory 2012 may include one or more computer programs including one or more host application programs 2014 and data 2016, which may include user data, e.g., data generated by a UE for the host 2000 or data generated by the host 2000 for a UE. Embodiments of the host 2000 may utilize only a subset or all of the components shown. The host application programs 2014 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 2014 may also provide for user authentication and licensing checks and may periodically report health, routes, and content availability to a central node, such as a device in or on the edge of a core network. Accordingly, the host 2000 may select and/or indicate a different host for over-the-top services for a UE. The host application programs 2014 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 21 is a block diagram illustrating a virtualization environment 2100 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2102 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 2104 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2106 (also referred to as hypervisors or virtual machine monitors (VMMs)), provide VMs 2108a and 2108b (one or more of which may be generally referred to as VMs 2108), and/or perform any of the functions, features and/or benefits described in relation with some embodiments described herein. The virtualization layer 2106 may present a virtual operating platform that appears like networking hardware to the VMs 2108.

The VMs 2108 comprise virtual processing, virtual memory, virtual networking or interface and virtual storage, and may be run by a corresponding virtualization layer 2106. Different embodiments of the instance of a virtual appliance 2102 may be implemented on one or more of VMs 2108, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2108 may be a software implementation of a physical machine that runs programs as if they were executing on a physical, non-virtualized machine. Each of the VMs 2108, and that part of hardware 2104 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2108 on top of the hardware 2104 and corresponds to the application 2102.

Hardware 2104 may be implemented in a standalone network node with generic or specific components. Hardware 2104 may implement some functions via virtualization. Alternatively, hardware 2104 may be part of a larger cluster of hardware (e.g. such as in a data center or CPE) where many hardware nodes work together and are managed via management and orchestration 2110, which, among others, oversees lifecycle management of applications 2102. In some embodiments, hardware 2104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2112 which may alternatively be used for communication between hardware nodes and radio units.

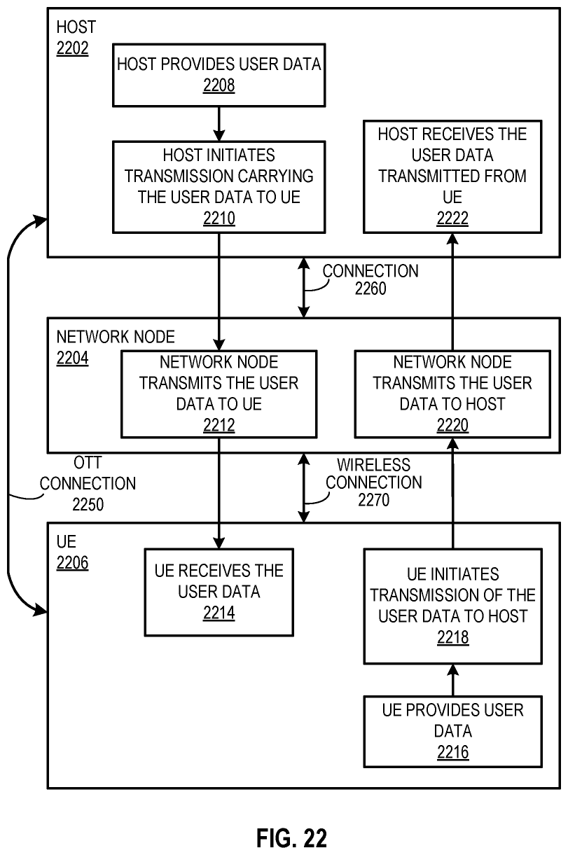

FIG. 22 shows a communication diagram of a host 2202 communicating via a network node 2204 with a UE 2206 over a partially wireless connection in accordance with some embodiments. Example implementations, in accordance with various embodiments, of the UE (such as a UE 1712a of FIG. 17 and/or UE 1800 of FIG. 18), network node (such as network node 1710a of FIG. 17 and/or network node 1900 of FIG. 19), and host (such as host 1716 of FIG. 17 and/or host 2000 of FIG. 20) discussed in the preceding paragraphs will now be described with reference to FIG. 22.

Like host 2000, embodiments of host 2202 include hardware, such as a communication interface, processing circuitry, and memory. The host 2202 also includes software, which is stored in or accessible by the host 2202 and executable by the processing circuitry. The software includes a host application that may be operable to provide a service to a remote user, such as the UE 2206 connecting via an over-the-top (OTT) connection 2250 extending between the UE 2206 and host 2202. In providing the service to the remote user, a host application may provide user data which is transmitted using the OTT connection 2250.

The network node 2204 includes hardware enabling it to communicate with the host 2202 and UE 2206. The connection 2260 may be direct or pass through a core network (like core network 1706 of FIG. 17) and/or one or more other intermediate networks, such as one or more public, private, or hosted networks. For example, an intermediate network may be a backbone network or the Internet.

The UE 2206 includes hardware and software, which is stored in or accessible by UE 2206 and executable by the UE's processing circuitry. The software includes a client application, such as a web browser or operator-specific “app” that may be operable to provide a service to a human or non-human user via UE 2206 with the support of the host 2202. In the host 2202, an executing host application may communicate with the executing client application via the OTT connection 2250 terminating at the UE 2206 and host 2202. In providing the service to the user, the U″s client application may receive request data from the hos “s host application and provide user data in response to the request data. The OTT connection 2250 may transfer both the request data and the user data. The U”'s client application may interact with the user to generate the user data that it provides to the host application through the OTT connection 2250. The OTT connection 2250 may extend via a connection 2260 between the host 2202 and the network node 2204 and via a wireless connection 2270 between the network node 2204 and the UE 2206 to provide the connection between the host 2202 and the UE 2206. The connection 2260 and wireless connection 2270, over which the OTT connection 2250 may be provided, have been drawn abstractly to illustrate the communication between the host 2202 and the UE 2206 via the network node 2204, without explicit reference to any intermediary devices and the precise routing of messages via these devices.

As an example of transmitting data via the OTT connection 2250, in step 2208, the host 2202 provides user data, which may be performed by executing a host application. In some embodiments, the user data is associated with a particular human user interacting with the UE 2206. In other embodiments, the user data is associated with a UE 2206 that shares data with the host 2202 without explicit human interaction. In step 2210, the host 2202 initiates a transmission carrying the user data towards the UE 2206. The host 2202 may initiate the transmission responsive to a request transmitted by the UE 2206. The request may be caused by human interaction with the UE 2206 or by operation of the client application executing on the UE 2206. The transmission may pass via the network node 2204, in accordance with the teachings of the embodiments described throughout this disclosure. Accordingly, in step 2212, the network node 2204 transmits to the UE 2206 the user data that was carried in the transmission that the host 2202 initiated, in accordance with the teachings of the embodiments described throughout this disclosure. In step 2214, the UE 2206 receives the user data carried in the transmission, which may be performed by a client application executed on the UE 2206 associated with the host application executed by the host 2202.

In some examples, the UE 2206 executes a client application which provides user data to the host 2202. The user data may be provided in reaction or response to the data received from the host 2202. Accordingly, in step 2216, the UE 2206 may provide user data, which may be performed by executing the client application. In providing the user data, the client application may further consider user input received from the user via an input/output interface of the UE 2206. Regardless of the specific manner in which the user data was provided, the UE 2206 initiates, in step 2218, transmission of the user data towards the host 2202 via the network node 2204. In step 2220, in accordance with the teachings of the embodiments described throughout this disclosure, the network node 2204 receives user data from the UE 2206 and initiates transmission of the received user data towards the host 2202. In step 2222, the host 2202 receives the user data carried in the transmission initiated by the UE 2206.

One or more of the various embodiments improve the performance of OTT services provided to the UE 2206 using the OTT connection 2250, in which the wireless connection 2270 forms the last segment.

In an example scenario, factory status information may be collected and analyzed by the host 2202. As another example, the host 2202 may process audio and video data which may have been retrieved from a UE for use in creating maps. As another example, the host 2202 may collect and analyze real-time data to assist in controlling vehicle congestion (e.g., controlling traffic lights). As another example, the host 2202 may store surveillance video uploaded by a UE. As another example, the host 2202 may store or control access to media content such as video, audio, VR or AR which it can broadcast, multicast or unicast to UEs. As other examples, the host 2202 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 2250 between the host 2202 and UE 2206, in response to variations in the measurement results. The measurement procedure and/or the network functionality for reconfiguring the OTT connection may be implemented in software and hardware of the host 2202 and/or UE 2206. In some embodiments, sensors (not shown) may be deployed in or in association with other devices through which the OTT connection 2250 passes; the sensors may participate in the measurement procedure by supplying values of the monitored quantities exemplified above, or supplying values of other physical quantities from which software may compute or estimate the monitored quantities. The reconfiguring of the OTT connection 2250 may include message format, retransmission settings, preferred routing etc.; the reconfiguring need not directly alter the operation of the network node 2204. Such procedures and functionalities may be known and practiced in the art. In certain embodiments, measurements may involve proprietary UE signaling that facilitates measurements of throughput, propagation times, latency and the like, by the host 2202. The measurements may be implemented in that software causes messages to be transmitted, in particular empty or ‘dummy’ messages, using the OTT connection 2250 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Example embodiments of the techniques and apparatus described herein include, but are not limited to, the following enumerated examples:

### Group A Embodiments

A1. A method performed by a communication device, the method comprising:
receiving data units on logical channels; and
scheduling the received data units for transmission based on a priority order of the logical channels and based on timing information for the data units.

A2. The method of embodiment A1, wherein the timing information includes, for each data unit, a time budget remaining for the data unit to meet a timing requirement.

A3. The method of embodiment A2, wherein the data units are packets, wherein the timing requirement for a packet is a packet delay budget, and wherein the time budget remaining for a packet comprises an amount of time left before the packet must be delivered to a reference point in order to meet the packet delay budget for the packet.

A4. The method of any of embodiments A2-A3, further comprising associating each data unit with a priority based on the time budget remaining for the data unit, wherein a data unit is associated with a higher priority the smaller the time budget remaining for the data unit, wherein said scheduling comprises scheduling the data units for transmission based on the priority order of the logical channels and based on the priorities associated with the data units.

A5. The method of embodiment A4, wherein said associating comprises associating each data unit with one of multiple possible priorities based on within which one of multiple time budget ranges the time budget remaining for the data unit belongs.

A6. The method of any of embodiments A4-A5, wherein said associating comprises storing each data unit in a virtual queue based on the time budget remaining for the data unit, wherein each virtual queue has a priority, wherein each data unit is associated with the priority of the virtual queue within which the data unit is stored.

A7. The method of embodiment A6, wherein said scheduling comprises allocating transmission resources to the logical channels in a decreasing priority order, with transmission resources being allocated for a highest priority virtual queue first for all logical channels.

A8. The method of embodiment A6, wherein said scheduling comprises allocating transmission resources to the logical channels in a decreasing priority order, with transmission resources being allocated for transmission of all data units stored in a higher priority virtual queue before transmission resources are allocated for transmission of any data units stored in a lower priority virtual queue.

A9. The method of any of embodiments A6-A8, wherein said scheduling comprises selecting logical channels to which to allocate transmission resources based on a variable computed per logical channel and per virtual queue, wherein the variable is computed as a function of: a prioritized bit rate per logical channel and per virtual queue; and a bucket size duration per logical channel and per virtual queue.

A10. The method of any of embodiments A4-A9, wherein said scheduling comprises allocating transmission resources to the logical channels in a decreasing priority order, with transmission resources being allocated for transmission of all data units associated with a higher priority before transmission resources are allocated for transmission of any data units associated with a lower priority.

A11. The method of any of embodiments A1-A10, further comprising storing the received data units in buffers at the wireless communication device respectively associated with the logical channels on which the data units are received, wherein the timing information for the data units includes, for each data unit, an amount of time that the data unit has been stored in one of the buffers.

A12. The method of any of embodiments A1-A11, wherein receiving the data units comprises receiving the data units on logical channels at a medium access control (MAC) layer of the communication device or at a MAC entity of the communication device.

A13. The method of any of embodiments A1-A12, wherein the data units are medium access control (MAC) service data units (SDUs).

A14. The method of any of embodiments A1-A13, wherein said scheduling comprises allocating transmission resources for transmission of the data units, wherein the transmission resources correspond to available spaces in a data block to be transmitted during a transmission time interval at the communication device.

A15. The method of any of embodiments A1-A14, further comprising receiving, from a network node, signaling indicating one or more of:
one or more thresholds governing prioritization for scheduling data units for transmission based on timing information for data units;
how many virtual queues data units are to be stored across according to timing information for the data units;
a prioritized bit rate per logical channel and per virtual queue buffer; or
a bucket size duration per logical channel and per virtual queue.

A16. The method of any of embodiments A1-A15, wherein said scheduling comprises allocating transmission resources to the logical channels based on the priority order of the logical channels and based on the timing information for the data units.

AA1. A method performed by a communication device, the method comprising:
storing data units in buffers based on timing information for the data units; and
scheduling the data units in the buffers for transmission based on a priority order of the buffers.

AA2. The method of embodiment AA1, wherein the timing information includes, for each data unit, a time budget remaining for the data unit to meet a timing requirement.

AA3. The method of embodiment AA2, wherein the data units are packets, wherein the timing requirement for a packet is a packet delay budget, and wherein the time budget remaining for a packet comprises an amount of time left before the packet must be delivered to a reference point in order to meet the packet delay budget for the packet.

AA4. The method of any of embodiments AA2-AA3, wherein different buffers are for different respective ranges of time budgets remaining, wherein a buffer for a range of smaller time budgets remaining is prioritized in the priority order higher than a buffer for a range of larger time budgets remaining.

AA5. The method of embodiment AA4, wherein said storing comprises, for each data unit, determining which one of the ranges a time budget remaining for the data unit is included and storing the data unit in the buffer that is for the determined range.

AA6. The method of any of embodiments AA1-AA5, wherein said scheduling comprises allocating transmission resources for transmission of data units in the buffers in a decreasing priority order of the buffers.

AA7. The method of any of embodiments AA1-AA6, wherein said scheduling comprises allocating transmission resources for transmission of data units in the buffers in a decreasing priority order of the buffers, with transmission resources being allocated for transmission of all data units stored in a higher priority buffer before transmission resources are allocated for transmission of any data units stored in a lower priority buffer.

AA8. The method of any of embodiments AA6-AA7, wherein said scheduling comprises selecting buffers to which to allocate transmission resources based on a variable computed per buffer, wherein the variable is computed as a function of:
a prioritized bit rate per buffer; and
a bucket size duration per buffer.

AA9. The method of any of embodiments AA1-AA8, wherein the timing information for the data units includes, for each data unit, an amount of time that the data unit has been stored in one of the buffers.

AA10. The method of any of embodiments AA1-AA9, wherein the data units are received at a medium access control (MAC) layer of the communication device or at a MAC entity of the communication device.

AA11. The method of any of embodiments AA1-AA10, wherein the data units are medium access control (MAC) service data units (SDUs).

AA12. The method of any of embodiments AA1-AA10, wherein said scheduling comprises allocating transmission resources for transmission of the data units, wherein the transmission resources correspond to available spaces in a data block to be transmitted during a transmission time interval at the communication device.

AA13. The method of any of embodiments AA1-AA12, further comprising receiving, from a network node, signaling indicating one or more of:
one or more thresholds governing prioritization for scheduling the data units for transmission based on timing information for data units;
a prioritized bit rate per buffer; or
a bucket size duration per buffer.

AA14. The method of any of embodiments AA1-AA13, wherein said scheduling comprises allocating transmission resources for transmission of the data units in the buffers based on a priority order of the buffers.

AAA1. A method performed by a communication device, the method comprising:
receiving data units on logical channels that are associated with timing information for the data units; and
scheduling the data units for transmission based on a priority order of the logical channels.

AAA2. The method of embodiment AAA1, wherein the timing information includes, for each data unit, a time budget remaining for the data unit to meet a timing requirement.

AAA3. The method of embodiment AAA2, wherein the data units are packets, wherein the timing requirement for a packet is a packet delay budget, and wherein the time budget remaining for a packet comprises an amount of time left before the packet must be delivered to a reference point in order to meet the packet delay budget for the packet.

AAA4. The method of any of embodiments AAA2-AAA3, wherein each data unit is received on a logical channel that is associated with the time budget remaining for the data unit.

AAA5. The method of embodiment AAA4, wherein different ones of the logical channels are associated with different respective time budget ranges remaining for the data units.

AAA6. The method of any of embodiments AAA1-AAA5, wherein receiving the data units comprises receiving the data units on logical channels at a medium access control (MAC) layer of the communication device or at a MAC entity of the communication device.

AAA7. The method of any of embodiments AAA1-AAA6, wherein the data units are medium access control (MAC) service data units (SDUs).

AAA8. The method of any of embodiments AAA1-AAA7, wherein said scheduling comprises allocating transmission resources for transmission of the data units, wherein the transmission resources correspond to available spaces in a data block to be transmitted during a transmission time interval at the communication device.

AAA9. The method of any of embodiments AAA1-AAA8, wherein said scheduling comprises selecting which logical channels to allocate transmission resources and allocating transmission resources to the selected logical channels in a decreasing priority order.

AAAA1. A method performed by a communication device, the method comprising:
receiving, from a network node, signaling indicating one or more of:
   one or more thresholds governing prioritization for performing transmission scheduling based on timing information for data units;
   how many virtual queues data units are to be stored across according to timing information for the data units;
   a prioritized bit rate per logical channel and per virtual queue or a prioritized bit rate per buffer; or
   a bucket size duration per logical channel and per virtual queue or a bucket size duration per buffer.

AAAA2. The method of embodiment AAAA1, further comprising performing transmission scheduling based on the signaling.

AAAA3. The method of any of embodiments AAAA1-AAAA2, wherein the one or more thresholds comprise one or more time budget remaining thresholds governing definition of time budget ranges at the communication device, wherein the time budget ranges are associated with respective priorities at the communication device.

AA. The method of any of the previous embodiments, further comprising:
providing user data; and
forwarding the user data to a host computer via the transmission to a base station.

### Group B Embodiments

B1. A method performed by a network node configured for use in a communication network, the method comprising:
transmitting, to a communication device, signaling indicating one or more of:
   one or more thresholds governing prioritization according to which the communication device is to perform transmission scheduling based on timing information for data units;
   how many virtual queues data units are to be stored across by the communication device according to timing information for the data units;
   a prioritized bit rate per logical channel and per virtual queue or a prioritized bit rate per buffer; or
   a bucket size duration per logical channel and per virtual queue or a bucket size duration per buffer.

B2. The method of embodiment B1, further comprising receiving data units from the communication device scheduled based on the signaling.

B3. The method of any of embodiments B1-B2, wherein the one or more thresholds comprise one or more time budget remaining thresholds governing definition of time budget ranges at the communication device, wherein the time budget ranges are associated with respective priorities at the communication device.

### Group C Embodiments

C1. A communication device configured to perform any of the steps of any of the Group A embodiments.

C2. A communication device comprising processing circuitry configured to perform any of the steps of any of the Group A embodiments.

C3. A communication device comprising:
communication circuitry; and
processing circuitry configured to perform any of the steps of any of the Group A embodiments.

C4. A communication device comprising:
processing circuitry configured to perform any of the steps of any of the Group A embodiments; and
power supply circuitry configured to supply power to the communication device.

C5. A communication device comprising:
processing circuitry and memory, the memory containing instructions executable by the processing circuitry whereby the communication device is configured to perform any of the steps of any of the Group A embodiments.

C6. A user equipment (UE) comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

C7. A computer program comprising instructions which, when executed by at least one processor of a communication device, causes the communication device to carry out the steps of any of the Group A embodiments.

C8. A carrier containing the computer program of embodiment C7, wherein the carrier is one of an electronic signal, optical signal, radio signal, or computer readable storage medium.

C9. A network node configured to perform any of the steps of any of the Group B embodiments.

C10. A network node comprising processing circuitry configured to perform any of the steps of any of the Group B embodiments.

C11. A network node comprising:
communication circuitry; and
processing circuitry configured to perform any of the steps of any of the Group B embodiments.

C12. A network node comprising:
processing circuitry configured to perform any of the steps of any of the Group B embodiments;
power supply circuitry configured to supply power to the network node.

C13. A network node comprising:
processing circuitry and memory, the memory containing instructions executable by the processing circuitry whereby the network node is configured to perform any of the steps of any of the Group B embodiments.

C14. The network node of any of embodiments C9-C13, wherein the network node is a base station.

C15. A computer program comprising instructions which, when executed by at least one processor of a network node, causes the network node to carry out the steps of any of the Group B embodiments.

C16. The computer program of embodiment C14, wherein the network node is a base station.

C17. A carrier containing the computer program of any of embodiments C15-C16, wherein the carrier is one of an electronic signal, optical signal, radio signal, or computer readable storage medium.

### Group D Embodiments

D1. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform any of the steps of any of the Group B embodiments.

D2. The communication system of the previous embodiment further including the base station.

D3. The communication system of the previous 2 embodiments, further including the UE, wherein the UE is configured to communicate with the base station.

D4. The communication system of the previous 3 embodiments, wherein:
the processing circuitry of the host computer is configured to execute a host application, thereby providing the user data; and
the UE comprises processing circuitry configured to execute a client application associated with the host application.

D5. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs any of the steps of any of the Group B embodiments.

D6. The method of the previous embodiment, further comprising, at the base station, transmitting the user data.

D7. The method of the previous 2 embodiments, wherein the user data is provided at the host computer by executing a host application, the method further comprising, at the UE, executing a client application associated with the host application.

D8. A user equipment (UE) configured to communicate with a base station, the UE comprising a radio interface and processing circuitry configured to perform any of the previous 3 embodiments.

D9. A communication system including a host computer comprising:
processing circuitry configured to provide user data; and
a communication interface configured to forward user data to a cellular network for transmission to a user equipment (UE),
wherein the UE comprises a radio interface and processing circuitry, the UE's components configured to perform any of the steps of any of the Group A embodiments.

D10. The communication system of the previous embodiment, wherein the cellular network further includes a base station configured to communicate with the UE.

D11. The communication system of the previous 2 embodiments, wherein:
the processing circuitry of the host computer is configured to execute a host application, thereby providing the user data; and
the UE's processing circuitry is configured to execute a client application associated with the host application.

D12. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs any of the steps of any of the Group A embodiments.

D13. The method of the previous embodiment, further comprising at the UE, receiving the user data from the base station.

D14. A communication system including a host computer comprising:
communication interface configured to receive user data originating from a transmission from a user equipment (UE) to a base station,
wherein the UE comprises a radio interface and processing circuitry, the UE's processing circuitry configured to perform any of the steps of any of the Group A embodiments.

D15. The communication system of the previous embodiment, further including the UE.

D16. The communication system of the previous 2 embodiments, further including the base station, wherein the base station comprises a radio interface configured to communicate with the UE and a communication interface configured to forward to the host computer the user data carried by a transmission from the UE to the base station.

D17. The communication system of the previous 3 embodiments, wherein:
the processing circuitry of the host computer is configured to execute a host application; and
the UE's processing circuitry is configured to execute a client application associated with the host application, thereby providing the user data.

D18. The communication system of the previous 4 embodiments, wherein:
the processing circuitry of the host computer is configured to execute a host application, thereby providing request data; and
the UE's processing circuitry is configured to execute a client application associated with the host application, thereby providing the user data in response to the request data.

D19. A method implemented in a communication system including a host computer, a base station and a user equipment (UE), the method comprising:
at the host computer, receiving user data transmitted to the base station from the UE, wherein the UE performs any of the steps of any of the Group A embodiments.

D20. The method of the previous embodiment, further comprising, at the UE, providing the user data to the base station.

D21. The method of the previous 2 embodiments, further comprising:
at the UE, executing a client application, thereby providing the user data to be transmitted; and
at the host computer, executing a host application associated with the client application.

D22. The method of the previous 3 embodiments, further comprising:
at the UE, executing a client application; and
at the UE, receiving input data to the client application, the input data being provided at the host computer by executing a host application associated with the client application,
wherein the user data to be transmitted is provided by the client application in response to the input data.

D23. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.

D24. The communication system of the previous embodiment further including the base station.

D25. The communication system of the previous 2 embodiments, further including the UE, wherein the UE is configured to communicate with the base station.

D26. The communication system of the previous 3 embodiments, wherein:
the processing circuitry of the host computer is configured to execute a host application;
the UE is configured to execute a client application associated with the host application, thereby providing the user data to be received by the host computer.

D27. A method implemented in a communication system including a host computer, a base station and a user equipment (UE), the method comprising:
at the host computer, receiving, from the base station, user data originating from a transmission which the base station has received from the UE, wherein the UE performs any of the steps of any of the Group A embodiments.

D28. The method of the previous embodiment, further comprising at the base station, receiving the user data from the UE.

D29. The method of the previous 2 embodiments, further comprising at the base station, initiating a transmission of the received user data to the host computer.

1. A method performed by a communication device, the method comprising:
receiving data units on logical channels; and
scheduling the received data units for transmission based on a priority order of the logical channels and based on timing information for the data units, the timing information including, for each data unit, a time budget remaining for the data unit to meet a timing requirement.

2. The method of claim 1, wherein the data units are packets, wherein the timing requirement for a packet is a packet delay budget, and wherein the time budget remaining for a packet comprises an amount of time left before the packet must be delivered to a reference point in order to meet the packet delay budget for the packet.

3. The method of claim 1, further comprising associating each data unit with a priority based on the time budget remaining for the data unit, wherein a data unit is associated with a higher priority the smaller the time budget remaining for the data unit, wherein the scheduling comprises scheduling the data units for transmission based on the priority order of the logical channels and based on the priorities associated with the data units.

4. The method of claim 3, wherein the associating comprises associating each data unit with one of multiple possible priorities based on within which one of multiple time budget ranges the time budget remaining for the data unit belongs.

5. The method of claim 3, wherein the associating comprises storing each data unit in a virtual queue based on the time budget remaining for the data unit, wherein each virtual queue has a priority, wherein each data unit is associated with the priority of the virtual queue within which the data unit is stored.

6. The method of claim 5, wherein the scheduling comprises allocating transmission resources to the logical channels in a decreasing priority order, wherein:
transmission resources are allocated for a highest priority virtual queue first for all logical channels; or
transmission resources are allocated for transmission of all data units stored in a higher priority virtual queue before transmission resources are allocated for transmission of any data units stored in a lower priority virtual queue.

7. The method of claim 5, wherein the scheduling comprises selecting logical channels to which to allocate transmission resources based on a variable computed per logical channel and per virtual queue, wherein the variable is computed as a function of:
a prioritized bit rate per logical channel and per virtual queue; and
a bucket size duration per logical channel and per virtual queue.

8. The method of claim 3, wherein the scheduling comprises allocating transmission resources to the logical channels in a decreasing priority order, with transmission resources being allocated for transmission of all data units associated with a higher priority before transmission resources are allocated for transmission of any data units associated with a lower priority.

9. The method of claim 1, further comprising storing the received data units in buffers at the wireless communication device respectively associated with the logical channels on which the data units are received, wherein the timing information for the data units further includes, for each data unit, an amount of time that the data unit has been stored in one of the buffers.

10. The method of claim 1, wherein receiving the data units comprises receiving the data units on logical channels at a medium access control (MAC) layer of the communication device or at a MAC entity of the communication device, wherein the data units are medium access control (MAC) service data units (SDUs).

11. The method of claim 1, wherein the scheduling comprises allocating transmission resources for transmission of the data units, wherein the transmission resources correspond to available spaces in a data block to be transmitted during a transmission time interval at the communication device.

12. The method of claim 1, further comprising receiving, from a network node, signaling indicating one or more of:
one or more thresholds governing prioritization for scheduling data units for transmission based on timing information for data units;
how many virtual queues data units are to be stored across according to timing information for the data units;
a prioritized bit rate per logical channel and per virtual queue buffer; or
a bucket size duration per logical channel and per virtual queue.

13. (canceled)

14. (canceled)

15. A computer storage medium storing a computer program comprising instructions which, when executed by at least one processor of a communication device, causes the communication device to perform a method, the method comprising:
receiving data units on logical channels; and
scheduling the received data units for transmission based on a priority order of the logical channels and based on timing information for the data units, the timing information including, for each data unit, a time budget remaining for the data unit to meet a timing requirement.

16. (canceled)

17. A communication device comprising:
communication circuitry; and
processing circuitry configured to:
receive, via the communication circuitry, data units on logical channels; and
schedule the received data units for transmission based on a priority order of the logical channels and based on timing information for the data units, the timing information including, for each data unit, a time budget remaining for the data unit to meet a timing requirement.

18. The communication device of claim 17, wherein the data units are packets, wherein the timing requirement for a packet is a packet delay budget, and wherein the time budget remaining for a packet comprises an amount of time left before the packet must be delivered to a reference point in order to meet the packet delay budget for the packet.

19. The method of claim 2, further comprising associating each data unit with a priority based on the time budget remaining for the data unit, wherein a data unit is associated with a higher priority the smaller the time budget remaining for the data unit, wherein the scheduling comprises scheduling the data units for transmission based on the priority order of the logical channels and based on the priorities associated with the data units.

20. The method of claim 19, wherein the associating comprises associating each data unit with one of multiple possible priorities based on within which one of multiple time budget ranges the time budget remaining for the data unit belongs.

21. The method of claim 19, wherein the associating comprises storing each data unit in a virtual queue based on the time budget remaining for the data unit, wherein each virtual queue has a priority, wherein each data unit is associated with the priority of the virtual queue within which the data unit is stored.

22. The method of claim 21, wherein the scheduling comprises allocating transmission resources to the logical channels in a decreasing priority order, wherein:
transmission resources are allocated for a highest priority virtual queue first for all logical channels; or
transmission resources are allocated for transmission of all data units stored in a higher priority virtual queue before transmission resources are allocated for transmission of any data units stored in a lower priority virtual queue.

23. The method of claim 21, wherein the scheduling comprises selecting logical channels to which to allocate transmission resources based on a variable computed per logical channel and per virtual queue, wherein the variable is computed as a function of:
a prioritized bit rate per logical channel and per virtual queue; and
a bucket size duration per logical channel and per virtual queue.
